(19) United States
(12) Patent Application Publication
(10) Pub. No.: US 2007/0162675 A1
(43) Pub. Date: Jul. 12, 2007

(54) Interrupt control device

(76) Inventors: Shinji Sugiura, Osaka (JP); Tsuneo Uenishi, Hyogo (JP)

Correspondence Address: MCDERMOTT WILL & EMERY LLP, 600 13TH STREET, N.W., WASHINGTON, DC, 20005-3096, US

(21) Appl. No.: 11/634,391

(22) Filed: Dec. 6, 2006

(30) Foreign Application Priority Data
Dec. 6, 2005 (JP) 2005-352618

(51) Int. Cl. G06F 13/24

(52) U.S. Cl. 710/260

(57) ABSTRACT

To provide an interrupt control device for avoiding an unwanted transition to a low power mode without a decrease in software quality. The interrupt control device receives an interrupt, and also receives a switching instruction to switch a target device from a normal power mode to the low power mode, the switching instruction being included in a transition program showing a transition procedure from the normal to low power mode. The interrupt control device manages an interrupt state, by switching between a disable state of disabling any interrupt, a first enable state of enabling an interrupt in a period of the transition procedure, and a second enable state of enabling an interrupt in a period other than the period of the transition procedure. If the interrupt is received in the first enable state, the interrupt control device abandons the switching instruction when subsequently receiving the switching instruction.

This application is based on an application No. 2005-352618 filed in Japan, the contents of which are hereby incorporated by reference.

### BACKGROUND OF THE INVENTION

1. Field of the Invention

The present invention relates to techniques for controlling an operation of reducing a power consumption, in environments such as where devices are used in combination.

2. Related Art

To reduce a power consumption of a microprocessor, a device having a low power mode, i.e. a power saving function of stopping an operation clock to thereby stop a circuit operation, is widely used. One example of such a device is an interrupt control device having a low power mode.

An operation of this interrupt control device is briefly explained below. Suppose the microprocessor decides to enter the low power mode, by software execution. First, the microprocessor issues an interrupt disable instruction to disable interrupts to the interrupt control device, by software execution. Upon receiving the interrupt disable instruction, the interrupt control device disables interrupts by an external device. The microprocessor then issues an interrupt enable instruction to enable interrupts, by software execution. Upon receiving the interrupt enable instruction, the interrupt control device enables interrupts. After this, the microprocessor further issues a low power mode switching instruction to transition to the low power mode, by software execution. Upon receiving the low power mode switching instruction, the interrupt control device completes the transition to the low power mode by stopping a clock to the external device. Subsequently, if the interrupt control device receives an interrupt, the interrupt control device switches from the low power mode back to a normal mode, i.e. a non-power saving mode, and generates an interrupt signal for the received interrupt.

In this operation, if an interrupt occurs during a period from the issuance of the interrupt enable instruction to the issuance of the low power mode switching instruction, the interrupt control device receives that interrupt and generates an interrupt signal for the received interrupt, because interrupts are enabled during this period. In such a case, the transition to the low power mode is no longer necessary. However, when the microprocessor subsequently issues the low power mode switching instruction, the interrupt control device completes the transition to the low power mode. Thus, an unwanted transition to the low power mode is made.

To avoid such an unwanted transition to the low power mode, a technique of providing a jump instruction in software is used so as to suppress the transition to the low power mode if an interrupt is received during the period from the issuance of the interrupt enable instruction to the issuance of the low power mode switching instruction.

Also, Japanese Patent Application Publication No. 2000-284974 discloses a technique of suppressing the transition to the low power mode by performing an interrupt processing step which, when the low power mode switching instruction is issued after the occurrence of an interrupt, skips the low power mode switching instruction and instead executes the next instruction by hardware.

However, the technique of using a jump instruction in software is not preferable, because it is well known in the art that the use of a jump instruction leads to a decrease in software quality. Also, according to the technique disclosed in the above patent document, the low power mode switching instruction is skipped by hardware, which causes inconsistency in software data and results in a decrease in software quality.

In view of this, the present invention aims to provide an interrupt control device and control method that can suppress an unwanted transition to a low power mode without a decrease in software quality.

### SUMMARY OF THE INVENTION

The stated aim can be achieved by an interrupt control device for controlling an interrupt to a target device and switching of the target device between a normal power mode and a low power mode, including: an interrupt reception unit operable to receive the interrupt; an instruction reception unit operable to receive a switching instruction to switch the target device from the normal power mode to the low power mode, the switching instruction being included in a transition program showing a transition procedure from the normal power mode to the low power mode; a state management unit operable to manage an interrupt state, by switching between an interrupt disable state of disabling any interrupt, a first interrupt enable state of enabling an interrupt in a period of the transition procedure according to the transition program, and a second interrupt enable state of enabling an interrupt in a period other than the period of the transition procedure; and a transition control unit operable to, if the interrupt reception unit receives the interrupt in the first interrupt enable state, abandon the switching instruction when subsequently the instruction reception unit receives the switching instruction.

According to this construction, if an interrupt is received in the first interrupt enable state, the interrupt control device abandons the switching instruction when subsequently receiving the switching instruction, thereby suppressing the transition to the low power mode. In this way, an unwanted transition to the low power mode can be avoided. Also, there is no need to control the software that issues instructions, in order to deal with the case where an interrupt is received during the low power mode transition procedure. Accordingly, a decrease in software quality can be prevented.

Here, the transition control unit may manage a transition state indicating whether to permit transitioning from the normal power mode to the low power mode, wherein the transition control unit sets the transition state to a transition prohibition state of prohibiting transitioning to the low power mode when the interrupt reception unit receives the interrupt in the first interrupt enable state, and abandons the switching instruction when the instruction reception unit receives the switching instruction in the transition prohibition state.

According to this construction, the interrupt control device manages the transition state indicating whether to permit transitioning to the low power mode. The transition to the low power mode can be controlled in accordance with this transition state.

The stated aim can also be achieved by an interrupt control device for controlling an interrupt to a target device and switching of the target device between a normal power mode and a low power mode, including: an interrupt reception unit operable to receive the interrupt; an instruction reception unit operable to receive a switching instruction to switch the target device from the normal power mode to the low power mode, the switching instruction being included in a transition program showing a transition procedure from the normal power mode to the low power mode; an interrupt state management unit operable to manage an interrupt state, by switching between an interrupt enable state of enabling an interrupt and an interrupt disable state of disabling an interrupt; an operation state management unit operable to manage an operation state indicating whether the transition procedure according to the transition program is being performed, the operation state being set to a transition progress state if the transition procedure is being performed; and a transition control unit operable to, if the interrupt reception unit receives the interrupt in the interrupt disable state and the transition progress state, abandon the switching instruction when subsequently the instruction reception unit receives the switching instruction.

According to this construction, if an interrupt is received in the interrupt disable state and the transition progress state, the interrupt control device suppresses the transition to the low power mode when subsequently receiving the switching instruction. Hence an unwanted transition to the low power mode can be avoided. Also, there is no need to control the software that issues instructions, in order to deal with the case where an interrupt is received during the low power mode transition procedure. Accordingly, a decrease in software quality can be prevented.

Here, the transition control unit may manage a transition state indicating whether to permit transitioning from the normal power mode to the low power mode, wherein the transition control unit sets the transition state to a transition prohibition state of prohibiting transitioning to the low power mode when the interrupt reception unit receives the interrupt in the interrupt disable state and the transition progress state, and abandons the switching instruction when the instruction reception unit receives the switching instruction in the transition prohibition state, and the interrupt state management unit changes the interrupt state from the interrupt disable state to the interrupt enable state when the transition control unit abandons the switching instruction.

According to this construction, the interrupt control device manages the transition state indicating whether to permit transitioning to the low power mode. The transition to the low power mode can be controlled in accordance with this transition state.

Here, the interrupt control device may further include: an interrupt signal control unit operable to generate an interrupt signal for the interrupt received by the interrupt reception unit, when the instruction reception unit receives the switching instruction, wherein the transition control unit changes the transition state from the transition prohibition state to a transition permission state of permitting transitioning to the low power mode, upon detecting the interrupt signal generated by the interrupt signal control unit, and the operation state management unit changes the operation state from the transition progress state to a normal operation state indicating that the target device is in the normal power mode, when the transition control unit changes the transition state from the transition prohibition state to the transition permission state.

According to this construction, the interrupt control device can recover each state prior to the transition procedure, by generating the interrupt signal for the interrupt.

Here, the instruction reception unit may further receive normal mode information showing that the target device is in the normal power mode, wherein the operation state management unit changes the operation state from the transition progress state to a normal operation state indicating that the target device is in the normal power mode, when the instruction reception unit receives the normal mode information, and the transition control unit changes the transition state from the transition prohibition state to a transition permission state of permitting transitioning to the low power mode, when the instruction reception unit receives the normal mode information.

According to this construction, the interrupt control device can recover each state prior to the transition procedure, by receiving the normal mode information.

Here, the interrupt control device may control switching of a plurality of target devices between the normal power mode and the low power mode, wherein if the interrupt reception unit receives the interrupt in the interrupt disable state and the transition progress state, the transition control unit stops a clock to a target device except a main target device when subsequently the instruction reception unit receives the switching instruction, and the interrupt state management unit changes the interrupt state from the interrupt disable state to the interrupt enable state, when the transition control unit stops the clock.

According to this construction, the interrupt control device stops the clock to each target device except the main target device. Hence the main target device can exclusively be kept from transitioning to the low power mode.

Here, the interrupt control device may further include: an interrupt signal control unit operable to generate an interrupt signal for the interrupt received by the interrupt reception unit, when the instruction reception unit receives the switching instruction, wherein the transition control unit resumes the clock, upon detecting the interrupt signal generated by the interrupt signal control unit, and the operation state management unit changes the operation state from the transition progress state to a normal operation state indicating that all of the plurality of target devices are in the normal power mode, when the transition control unit resumes the clock.

According to this construction, the interrupt control device starts the clock to each target device except the main target device, by generating the interrupt signal for the interrupt. This reduces a time for recovering from the low power mode, when compared with the case where the clock to every target device needs to be started.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1 is a block diagram showing a construction of an interrupt control device according to a first embodiment of the present invention;

FIG. 2 is a flowchart showing an operation of the interrupt control device shown in FIG. 1, continuing to FIG. 3;

FIG. 3 is a flowchart showing the operation of the interrupt control device shown in FIG. 1, continuing from FIG. 2;

FIG. 4 is a timing chart showing a specific operation of the interrupt control device shown in FIG. 1;

FIG. 5 is a block diagram showing a construction of an interrupt control device according to a second embodiment of the present invention;

FIG. 6 is a flowchart showing an operation of the interrupt control device shown in FIG. 5, continuing to FIG. 7;

FIG. 7 is a flowchart showing the operation of the interrupt control device shown in FIG. 5, continuing from FIG. 6;

FIG. 8 is a timing chart showing a specific operation of the interrupt control device shown in FIG. 5;

FIG. 9 is a block diagram showing a construction of an interrupt control device according to a third embodiment of the present invention;

FIG. 10 is a flowchart showing an operation of the interrupt control device shown in FIG. 9, continuing to FIG. 11;

FIG. 11 is a flowchart showing the operation of the interrupt control device shown in FIG. 9, continuing from FIG. 10;

FIG. 12 is a timing chart showing a specific operation of the interrupt control device shown in FIG. 9;

FIG. 13 is a block diagram showing a construction of an interrupt control device according to a fourth embodiment of the present invention;

FIG. 14 is a flowchart showing an operation of the interrupt control device shown in FIG. 13, continuing to FIG. 15;

FIG. 15 is a flowchart showing the operation of the interrupt control device shown in FIG. 13, continuing from FIG. 14; and

FIG. 16 is a timing chart showing a specific operation of the interrupt control device shown in FIG. 13.

### DESCRIPTION OF THE PREFERRED EMBODIMENT(S)

### 1. First Embodiment

The following describes an interrupt control device 1 as a first embodiment of the present invention.

1.1. Construction

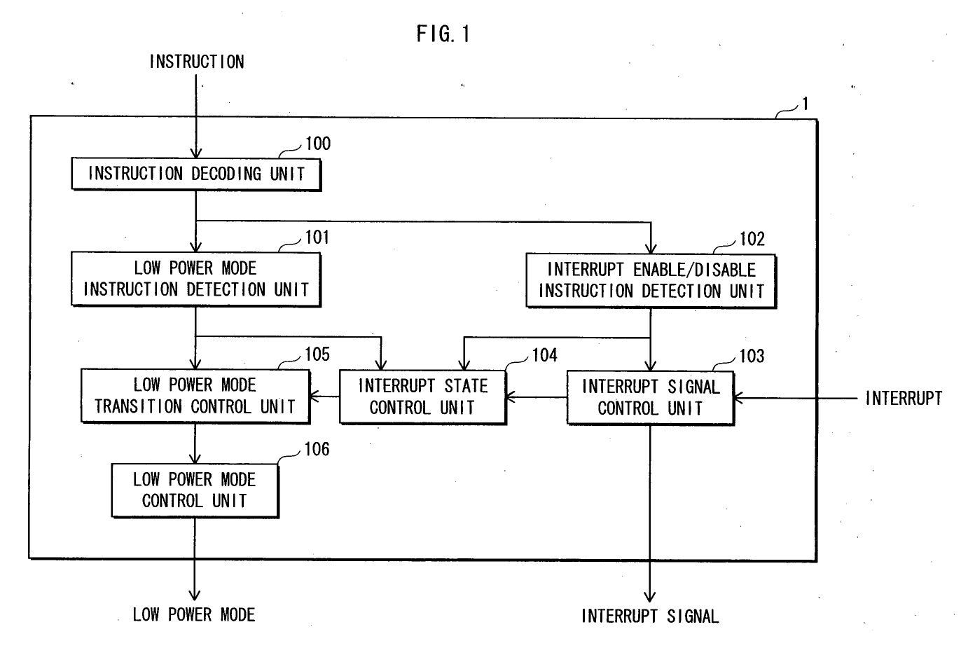

The interrupt control device 1 includes an instruction decoding unit 100, a low power mode instruction detection unit 101, an interrupt enable/disable instruction detection unit 102, an interrupt signal control unit 103, an interrupt state control unit 104, a low power mode transition control unit 105, and a low power mode control unit 106, as shown in FIG. 1.

The following describes each construction element in the case where a microprocessor decides to enter a low power mode by software execution.

Upon deciding to enter the low power mode, the microprocessor performs a procedure of transitioning to the low power mode by executing software. By performing the low power mode transition procedure, the microprocessor issues an interrupt disable instruction to disable interrupts, an interrupt enable instruction to enable interrupts, and a low power mode switching instruction to change a power consumption mode from a normal power mode (hereafter “normal mode”) to the low power mode, to the interrupt control device 1.

(1) Instruction Decoding Unit 100

The instruction decoding unit 100 receives an instruction issued by the microprocessor executing the software (the transition procedure), decodes the received instruction, and outputs a decoding result to the low power mode instruction detection unit 101 and the interrupt enable/disable instruction detection unit 102.

(2) Low Power Mode Instruction Detection Unit 101

The low power mode instruction detection unit 101 receives the decoding result from the instruction decoding unit 100, and judges whether the received decoding result is the low power mode switching instruction.

If the received decoding result is judged to be the low power mode switching instruction, the low power mode instruction detection unit 101 notifies the interrupt state control unit 104 and the low power mode transition control unit 105 of the reception of the low power mode switching instruction.

If the received decoding result is judged to be not the low power mode switching instruction, the low power mode instruction detection unit 101 abandons the received decoding result.

(3) Interrupt Enable/Disable Instruction Detection Unit 102

The interrupt enable/disable instruction detection unit 102 receives the decoding result from the instruction decoding unit 100, and judges whether the received decoding result is any of the interrupt disable instruction and the interrupt enable instruction.

If the received decoding result is judged to be the interrupt disable instruction, the interrupt enable/disable instruction detection unit 102 notifies the interrupt signal control, unit 103 and the interrupt state control unit 104 of the reception of the interrupt disable instruction.

If the received decoding result is judged to be the interrupt enable instruction, the interrupt enable/disable instruction detection unit 102 notifies the interrupt signal control unit 103 and the interrupt state control unit 104 of the reception of the interrupt enable instruction.

If the received decoding result is neither the interrupt disable instruction nor the interrupt enable instruction, the interrupt enable/disable instruction detection unit 102 abandons the received decoding result.

(4) Interrupt Signal Control Unit 103

The interrupt signal control unit 103 disables interrupts, upon being notified of the interrupt disable instruction from the interrupt enable/disable instruction detection unit 102.

The interrupt signal control unit 103 enables interrupts, upon being notified of the interrupt enable instruction from the interrupt enable/disable instruction detection unit 102.

Also, when receiving an interrupt (e.g. an external interrupt) in an interrupt enable state, the interrupt signal control unit 103 notifies the interrupt state control unit 104 of the reception of the interrupt, generates an interrupt signal for the received interrupt, and starts an interrupt handler process. In this case, the interrupt is processed by an external device.

When receiving an interrupt in an interrupt disable state, the interrupt signal control unit 103 abandons the received interrupt.

(5) Interrupt State Control Unit 104

The interrupt state control unit 104 manages (holds) an interrupt state in three states. The three states are an interrupt disable state, an interrupt enable state, and an interrupt disable expectation state. The interrupt disable state indicates a state where interrupts are disabled. The interrupt disable expectation state indicates a state where interrupts are enabled during the transition procedure, that is, while the transition to the low power mode is being performed. The interrupt enable state indicates a state where interrupts are enabled not during the transition procedure.

Upon being notified of the interrupt disable instruction from the interrupt enable/disable instruction detection unit 102, the interrupt state control unit 104 manages the interrupt state to be the interrupt disable state.

Upon being notified of the interrupt enable instruction from the interrupt enable/disable instruction detection unit 102, the interrupt state control unit 104 manages the interrupt state to be the interrupt disable expectation state.

Upon being notified of the low power mode switching instruction from the low power mode instruction detection unit 101, the interrupt state control unit 104 manages the interrupt state to be the interrupt enable state.

Upon being notified of the occurrence of the interrupt from the interrupt signal control unit 103, the interrupt state control unit 104 judges whether the current interrupt state is the interrupt disable expectation state or not.

If the current interrupt state is judged to be the interrupt disable expectation state, the interrupt state control unit 104 notifies the low power mode transition control unit 105 of the occurrence of the interrupt.

(6) Low Power Mode Transition Control Unit 105

The low power mode transition control unit 105 manages a transition state as to whether to transition to the low power mode, in two states. The two states are a transition permission state where the transition to the low power mode is permitted, and a transition prohibition state where the transition to the low power mode is prohibited.

The low power mode transition control unit 105 initially sets the transition state to be the transition permission state.

Upon being notified of the occurrence of the interrupt from the interrupt state control unit 104, the low power mode transition control unit 105 switches from the transition permission state to the transition prohibition state.

Upon receiving the low power mode switching instruction from the low power mode instruction detection unit 101, the low power mode transition control unit 105 judges whether the current transition state is the transition permission state or the transition prohibition state.

If the current transition state is judged to be the transition permission state, the low power mode transition control unit 105 notifies the low power mode control unit 106 to transition to the low power mode.

If the current transition state is judged to be the transition prohibition state, the low power mode transition control unit 105 abandons the received low power mode switching instruction, and changes the transition state to the transition permission state. In this case, the transition to the low power mode is not carried out.

(7) Low Power Mode Control Unit 106

The low power mode control unit 106 generates the low power mode, upon being notified to transition to the low power mode from the low power mode transition control unit 105. As a result, clocks of an external main device (e.g. a CPU) and peripheral device (e.g. a serial port, a USB, an SD card) are stopped to have the microprocessor enter the low power mode.

1.2. Operation

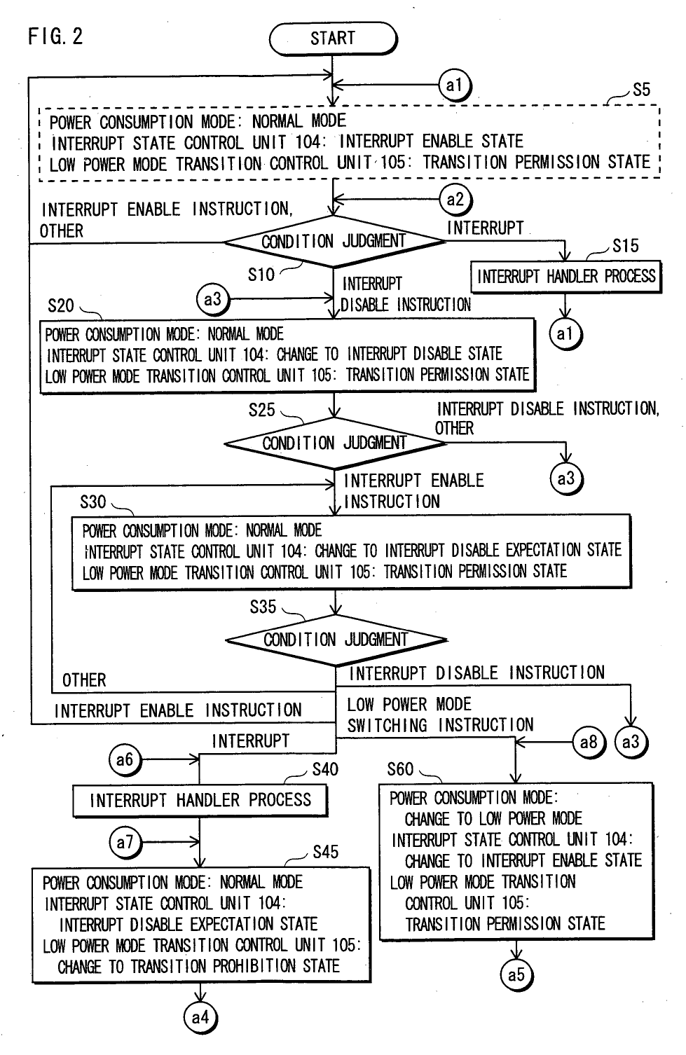

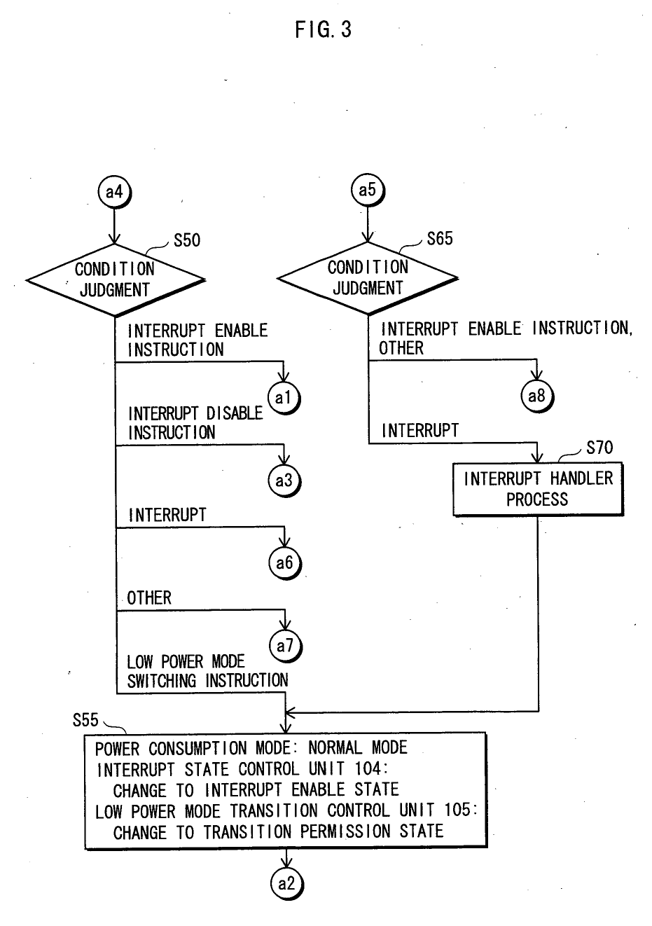

An operation of the interrupt control device 1 is described below, using flowcharts shown in FIGS. 2 and 3.

The interrupt control device 1 sets the power consumption mode to the normal mode, the interrupt state managed by the interrupt state control unit 104 to the interrupt enable state, and the transition state managed by the low power mode transition control unit 105 to the transition permission state (step S5).

The interrupt control device 1 judges whether an instruction is received, a type of the received instruction, and whether an interrupt occurs, through condition judgment (step S10).

When judging that an interrupt occurs (“interrupt” in step S10), the interrupt control device 1 performs the interrupt handler process (step S15) and returns to step S5.

When judging that the interrupt enable instruction is received or that no interrupt occurs and no instruction is received (“interrupt enable instruction, other” in step S10), the interrupt control device 1 returns to step S5.

When judging that the interrupt disable instruction is received (“interrupt disable instruction” in step S10), the interrupt control device 1 maintains the power consumption mode (the normal mode) and the transition state in the low power mode transition control unit 105 (the transition permission state), and changes the interrupt state in the interrupt state control unit 104 to the interrupt disable state (step S20).

The interrupt control device 1 judges whether an instruction is received, a type of the received instruction, and whether an interrupt occurs, through condition judgment (step S25).

When judging that the interrupt disable instruction is received or that no interrupt occurs and no instruction is received (“interrupt disable instruction, other” in step S25), the interrupt control device 1 returns to step S20.

When judging that the interrupt enable instruction is received (“interrupt enable instruction” in step S25) the interrupt control device 1 maintains the power consumption mode (the normal mode) and the transition state in the low power mode transition control unit 105 (the transition permission state), and changes the interrupt state in the interrupt state control unit 104 to the interrupt disable expectation state (step S30).

The interrupt control device 1 judges whether an instruction is received, a type of the received instruction, and whether an interrupt occurs, through condition judgment (step S35).

When judging that no interrupt occurs and no instruction is received (“other” in step S35), the interrupt control device 1 returns to step S30.

When judging that the interrupt enable instruction is received (“interrupt enable instruction” in step S35), the interrupt control device 1 returns to step S5.

When judging that the interrupt disable instruction is received (“interrupt disable instruction” in step S35), the interrupt control device 1 returns to step S20.

When judging that an interrupt occurs (“interrupt” in step S35), the interrupt control device 1 performs the interrupt handler process (step S40). Also, the interrupt control device 1 maintains the power consumption mode (the normal mode) and the interrupt state in the interrupt state control unit 104 (the interrupt disable expectation state), and changes the transition state in the low power mode transition control unit 105 to the transition prohibition state (step S45). The interrupt control device 1 judges whether an instruction is received, a type of the received instruction, and whether an interrupt occurs, through condition judgment (step S50). When judging that the interrupt enable instruction is received (“interrupt enable instruction” in step S50), the interrupt control device 1 returns to step S5. When judging that the interrupt disable instruction is received (“interrupt disable instruction” in step S50), the interrupt control device 1 returns to step S20. When judging that an interrupt occurs (“interrupt” in step S50), the interrupt control device 1 returns to step S40. When judging that no interrupt occurs and no instruction is received (“other” in step S50), the interrupt control device 1 returns to step S45. When judging that the low power mode switching instruction is received (“low power mode switching instruction” in step S50), the interrupt control device 1 maintains the power consumption mode (the normal mode), and changes the interrupt state in the interrupt state control unit 104 to the interrupt enable state and the transition state in the low power mode transition control unit 105 to the transition permission state (step S55).

Meanwhile, when judging that the low power mode switching instruction is received (“low power mode switching instruction” in step S35), the interrupt control device 1 maintains the transition state in the low power mode transition control unit 105 (the transition permission state), and changes the power consumption mode to the low power mode and the interrupt state in the interrupt state control unit 104 to the interrupt enable state (step S60). The interrupt control device 1 judges whether an instruction is received, a type of the received instruction, and whether an interrupt occurs, through condition judgment (step S65). When judging that the interrupt enable instruction is received or that no interrupt occurs and no instruction is received (“interrupt enable instruction, other” in step S65), the interrupt control device 1 returns to step S60. When judging that an interrupt occurs (“interrupt” in step S65), the interrupt control device 1 performs the interrupt handler process (step S70), and proceeds to step S55.

1.3. Specific Example

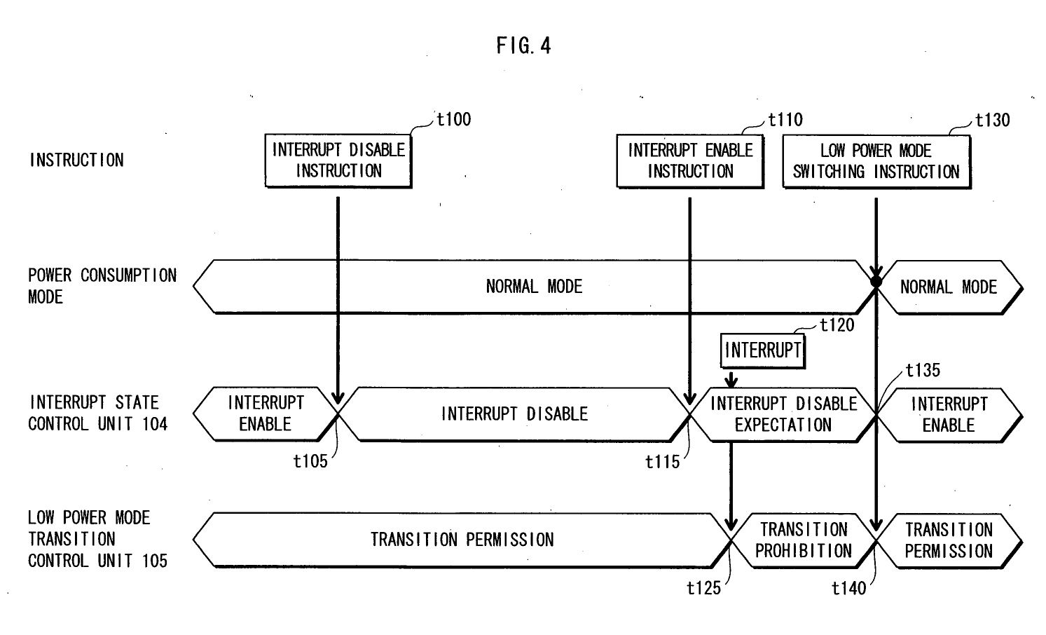

A specific operation of the interrupt control device 1 when an interrupt occurs during the period from the issuance of the interrupt enable instruction to the issuance of the low power mode switching instruction is described below, using a timing chart shown in FIG. 4.

When the microprocessor issues the interrupt disable instruction by executing the software (the transition procedure) (t100), the instruction decoding unit 100 notifies the low power mode instruction detection unit 101 and the interrupt enable/disable instruction detection unit 102 of the interrupt disable instruction.

Having received the interrupt disable instruction from the instruction decoding unit 100, the interrupt enable/disable instruction detection unit 102 notifies the interrupt signal control unit 103 and the interrupt state control unit 104 of the reception of the interrupt disable instruction. Upon being notified of the interrupt disable instruction from the interrupt enable/disable instruction detection unit 102, the interrupt signal control unit 103 disables interrupts. Upon being notified of the interrupt disable instruction from the interrupt enable/disable instruction detection unit 102, the interrupt state control unit 104 changes the interrupt state from the interrupt enable state to the interrupt disable state (t105).

When the microprocessor issues the interrupt enable instruction by executing the software (the transition procedure) (t110), the instruction decoding unit 100 notifies the low power mode instruction detection unit 101 and the interrupt enable/disable instruction detection unit 102 of the interrupt enable instruction.

Having received the interrupt enable instruction from the instruction decoding unit 100, the interrupt enable/disable instruction detection unit 102 notifies the interrupt signal control unit 103 and the interrupt state control unit 104 of the reception of the interrupt enable instruction. Upon being notified of the interrupt enable instruction from the interrupt enable/disable instruction detection unit 102, the interrupt signal control unit 103 enables interrupts. Upon being notified of the interrupt enable instruction from the interrupt enable/disable instruction detection unit 102, the interrupt state control unit 104 changes the interrupt state from the interrupt disable state to the interrupt disable expectation state (t115).

Upon receiving an interrupt when interrupts are enabled in the interrupt signal control unit 103 (t120), the interrupt signal control unit 103 notifies the interrupt state control unit 104 of the reception of the interrupt, and generates an interrupt signal for the received interrupt.

Upon being notified of the interrupt from the interrupt signal control unit 103, the interrupt state control unit 104 judges whether the current interrupt state is the interrupt disable expectation state. If the current interrupt state is judged to be the interrupt disable expectation state, the interrupt state control unit 104 notifies the low power mode transition control unit 105 of the interrupt. Upon being notified of the interrupt from the interrupt state control unit 104, the low power mode transition control unit 105 changes the transition state from the transition permission state to the transition prohibition state (t125).

When the microprocessor issues the low power mode switching instruction by executing the software (the transition procedure) (t130), the instruction decoding unit 100 notifies the low power mode instruction detection unit 101 and the interrupt enable/disable instruction detection unit 102 of the low power mode switching instruction.

Upon being notified of the low power mode switching instruction from the low power mode instruction detection unit 101, the interrupt state control unit 104 changes the interrupt state from the interrupt disable expectation state to the interrupt enable state (t135).

Upon being notified of the low power mode switching instruction from the low power mode instruction detection unit 101, the low power mode transition control unit 105 judges whether the current transition state is the transition permission state or the transition prohibition state. In this example, the low power mode transition control unit 105 judges the current transition state to be the transition prohibition state, abandons the received low power mode switching instruction, and changes the transition state from the transition prohibition state to the transition permission state (t140).

1.4. Modifications

Though the present invention has been described by way of the above first embodiment, the present invention should not be limited to the above. Example modifications are given below.

(1) The first embodiment describes the case where the low power mode transition control unit 105 manages whether to transition to the low power mode, through the use of the transition permission state and the transition prohibition state. However, the present invention is not limited to this.

For example, the management as to whether to transition to the low power mode may be made based on the interrupt state managed by the interrupt state control unit 104.

In this case, when notified of the interrupt from the interrupt signal control unit 103, the interrupt state control unit 104 holds the interrupt notification. Subsequently, when notified of the low power mode switching instruction from the low power mode instruction detection unit 101, the interrupt state control unit 104 manages the interrupt state to be the interrupt enable state, and then abandons the held interrupt notification.

When notified of the low power mode switching instruction from the low power mode instruction detection unit 101, the low power mode transition control unit 105 judges whether an interrupt occurs in the interrupt disable expectation state. Which is to say, the low power mode transition control unit 105 judges whether the interrupt state managed by the interrupt state control unit 104 is the interrupt disable expectation state and the interrupt state control unit 104 holds any interrupt notification. When judging that an interrupt occurs in the interrupt disable expectation state, the low power mode transition control unit 105 abandons the received low power mode switching instruction, and does not notify the low power mode control unit 106 to transition to the low power mode. When judging that no interrupt occurs in the interrupt disable expectation state, the low power mode transition control unit 105 notifies the low power mode control unit 106 to transition to the low power mode.

(2) The first embodiment and the above modification can freely be combined.

1.5. Conclusion

According to the first embodiment described above, if an interrupt occurs-during the period from when interrupts become enabled in the low power mode transition procedure to when the low power mode transition procedure is completed, the interrupt control device 1 suppresses an unwanted transition to the low power mode. As a result, a time for recovering from the low power mode can be saved.

### 2. Second Embodiment

The following describes an interrupt control device 2 as a second embodiment of the present invention.

2.1. Construction

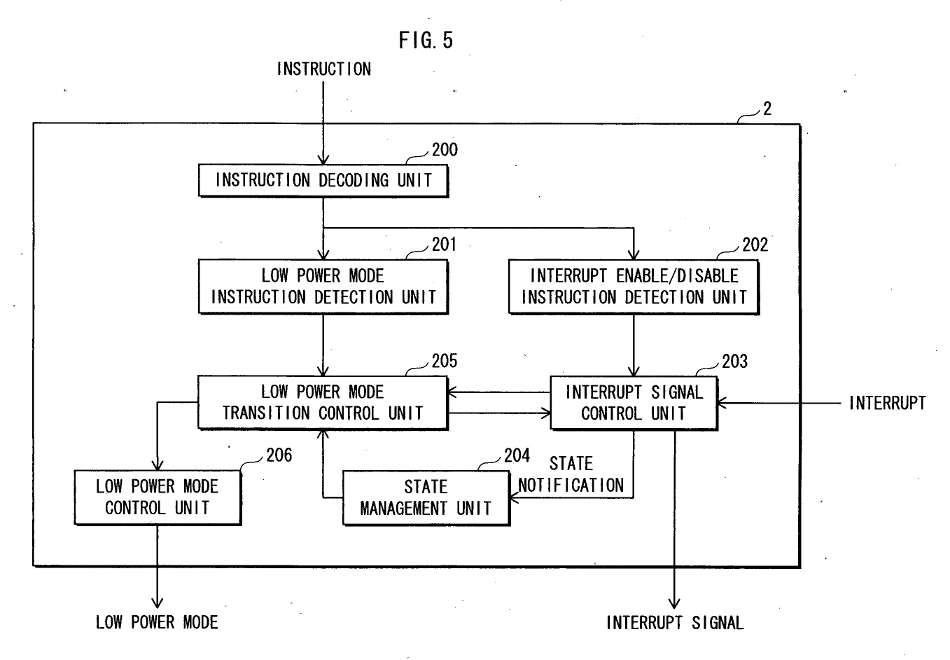

The interrupt control device 2 includes an instruction decoding unit 200, a low power mode instruction detection unit 201, an interrupt enable/disable instruction detection unit 202, an interrupt signal control unit 203, a state management unit 204, a low power mode transition control unit 205, and a low power mode control unit 206, as shown in FIG. 5.

The following explains each construction element in the case where a microprocessor decides to enter a low power mode as a result of software execution.

Upon deciding to enter the low power mode, the microprocessor performs a procedure to transition to the low power mode by executing software. By performing the low power mode transition procedure, the microprocessor issues an interrupt disable instruction to disable interrupts, an interrupt enable instruction to enable interrupts, and a low power mode switching instruction to change a power consumption mode from a normal power mode (hereafter “normal mode”) to the low power mode, to the interrupt control device 2.

(1) Instruction Decoding Unit 200

The instruction decoding unit 200 receives an instruction issued by the microprocessor executing the software (the transition procedure), decodes the received instruction, and outputs a decoding result to the low power mode instruction detection unit 201 and the interrupt enable/disable instruction detection unit 202.

(2) Low Power Mode Instruction Detection Unit 201

The low power mode instruction detection unit 201 receives the decoding result from the instruction decoding unit 200, and judges whether the received decoding result is the low power mode switching instruction.

If the received decoding result is judged to be the low power mode switching instruction, the low power mode instruction detection unit 201 notifies the low power mode transition control unit 205 of the reception of the low power mode switching instruction.

If the received decoding result is judged to be not the low power mode switching instruction, the low power mode instruction detection unit 201 abandons the received decoding result.

(3) Interrupt Enable/Disable Instruction Detection Unit 202

The interrupt enable/disable instruction detection unit 202 receives the decoding result from the instruction decoding unit 200, and judges whether the received decoding result is any of the interrupt disable instruction and the interrupt enable instruction.

If the received decoding result is judged to be the interrupt disable instruction, the interrupt enable/disable instruction detection unit 202 notifies the interrupt signal control unit 203 of the reception of the interrupt disable instruction.

If the received decoding result is judged to be the interrupt enable instruction, the interrupt enable/disable instruction detection unit 202 notifies the interrupt signal control unit 203 of the reception of the interrupt enable instruction.

If the received decoding result is neither the interrupt disable instruction nor the interrupt enable instruction, the interrupt enable/disable instruction detection unit 202 abandons the received decoding result.

(4) Interrupt Signal Control Unit 203

The interrupt signal control unit 203 disables interrupts, upon being notified of the interrupt disable instruction from the interrupt enable/disable instruction-detection unit 202. The interrupt signal control unit 203 then notifies the state management unit 204 of a low power mode transition progress state where the transition to the low power mode is in progress, as a state notification.

The interrupt signal control unit 203 enables interrupts, upon being notified of the interrupt enable instruction from the interrupt enable/disable instruction detection unit 202.

(When Interrupts are Disabled)

When receiving an interrupt (e.g. an external interrupt) in the interrupt disable state, the interrupt signal control unit 203 notifies the low power mode transition control unit 205 of the reception of the interrupt, and holds the received interrupt. Upon being notified of the low power mode switching instruction from the low power mode transition control unit 205, the interrupt signal control unit 203 enables interrupts, generates an interrupt signal for the held interrupt, and starts an interrupt handler process. The interrupt signal control unit 203 notifies the state management unit 204 and the low power mode transition control unit 205 of the generation of the interrupt signal for the held interrupt. In this case, the interrupt is processed by an external device.

Upon receiving an abandonment instruction to abandon the interrupt from the low power mode transition control unit 205, the interrupt signal control unit 203 abandons the held interrupt.

(When Interrupts are Enabled)

When receiving an interrupt in the interrupt enable state, the interrupt signal control unit 203 generates an interrupt signal for the received interrupt, and starts the interrupt handler process. In this case, the interrupt is processed by the external device.

(5) State Management Unit 204

The state management unit 204 manages (holds) an operation state, and notifies the low power mode transition control unit 205 of the managed operation state. The operation state managed by the state management unit 204 is any of a normal operation state where the microprocessor is operating in the normal mode, and the low power mode transition progress state where the microprocessor is transitioning to the low power mode, i.e. where the transition procedure is in progress.

Upon being notified of the low power mode transition progress state from the interrupt signal control unit 203, the state management unit 204 sets the operation state to be the low power mode transition progress state, and notifies the low power mode transition control unit 205 of the operation state.

Upon being notified of the generation of the interrupt signal from the interrupt signal control unit 203, the state management unit 204 sets the operation state to be the normal operation state, and notifies the low power mode transition control unit 205 of the operation state.

(6) Low Power Mode Transition Control Unit 205

The low power mode transition control unit 205 manages a transition state as to whether to transition to the low power mode, in two states. The two states are a transition permission state where the transition to the low power mode is permitted, and a transition prohibition state where the transition to the low power mode is prohibited.

The low power mode transition control unit 205 initially sets the transition permission state.

Upon being notified of the reception of the interrupt from the interrupt signal control unit 203, the low power mode transition control unit 205 judges whether the operation state notified by the state management unit 204 is the low power mode transition progress state. If the operation state is judged to be the low power mode transition progress state, the low power mode transition control unit 205 changes the transition state from the transition permission state to the transition prohibition state. If the operation state is judged to be not the low power mode transition progress state, the low power mode transition control unit 205 only outputs the abandonment instruction to the interrupt signal control unit 203, and does not change the transition state.

Upon receiving the low power mode switching instruction from the low power mode instruction detection unit 201, the low power mode transition control unit 205 judges whether the current transition state is the transition permission state or the transition prohibition state.

If the current transition state is judged to be the transition prohibition state, the low power mode transition control unit 205 notifies the interrupt signal control unit 203 of the reception of the low power mode switching instruction, and abandons the received low power mode switching instruction. In this case, the transition to the low power mode is not carried out. When notified of the generation of the interrupt signal from the interrupt signal control unit 203, the low power mode transition control unit 205 changes the transition state from the transition prohibition state to the transition permission state.

If the current transition state is judged to be the transition permission state, the low power mode transition control unit 205 notifies the low power mode control unit 206 to transition to the low power mode.

(7) Low Power Mode Control Unit 206

The low power mode control unit 206 generates the low power mode, when notified to transition to the low power mode from the low power mode transition control unit 205. As a result, clocks of an external main device (e.g. a CPU) and peripheral device (e.g. a serial port, a USB, an SD card) are stopped to have the microprocessor enter the low power mode.

2.2. Operation

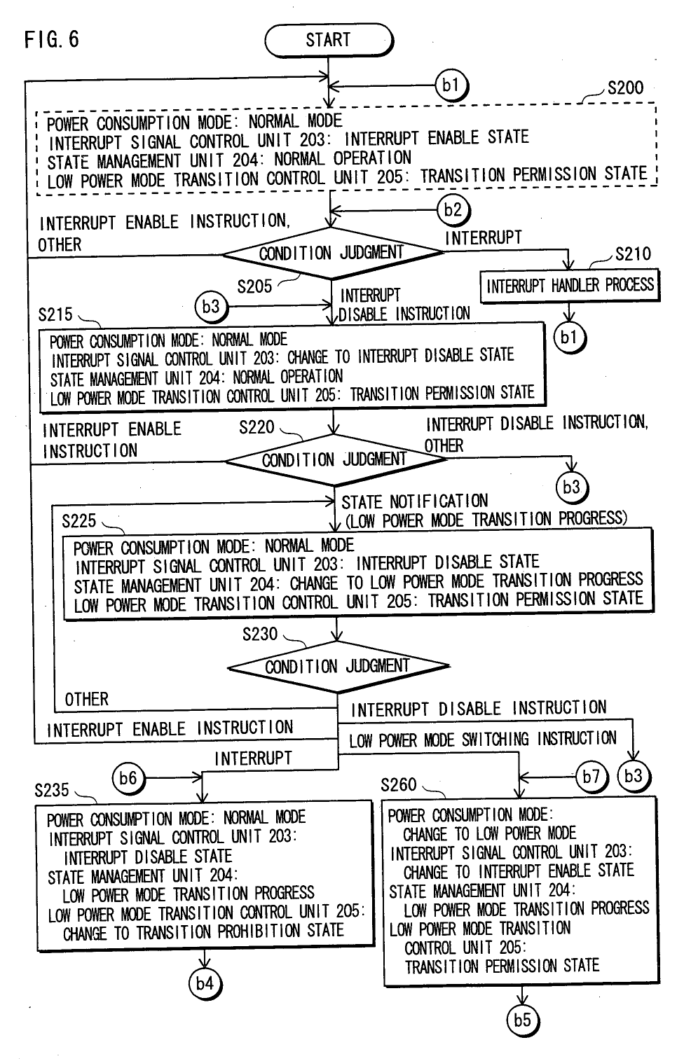

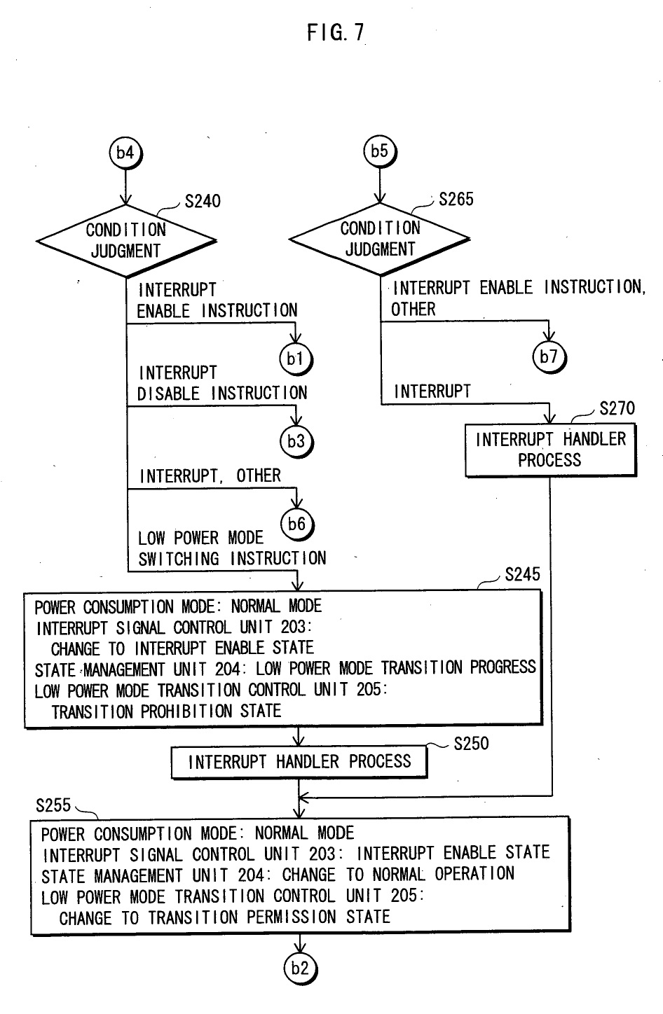

An operation of the interrupt control device 2 is described below, using flowcharts shown in FIGS. 6 and 7.

The interrupt control device 2 sets the power consumption mode to the normal mode, the interrupt state managed by the interrupt signal control unit 203 to the interrupt enable state, the operation state managed by the state management unit 204 to the normal operation state, and the transition state managed by the low power mode transition control unit 205 to the transition permission state (step S200).

The interrupt control device 2 judges whether an instruction is received, a type of the received instruction, and whether an interrupt occurs, through condition judgment (step S205).

When judging that an interrupt occurs (“interrupt” in step S205), the interrupt control device 2 performs the interrupt handler process (step S210) and returns to step S200.

When judging that the interrupt enable instruction is received or that no interrupt occurs and no instruction is received (“interrupt enable instruction, other” in step S205), the interrupt control device 2 returns to step S200.

When judging that the interrupt disable instruction is received (“interrupt disable instruction” in step S205), the interrupt control device 2 maintains the power consumption mode (the normal mode), the operation state in the state management unit 204 (the normal operation state), and the transition state in the low power mode transition control unit 205 (the transition permission state), and changes the interrupt state in the interrupt signal control unit 203 to the interrupt disable state (step S215).

The interrupt control device 2 judges whether an instruction is received, a type of the received instruction, and whether an interrupt occurs, through condition judgment (step S220).

When judging that the interrupt disable instruction is received or that no interrupt occurs and no instruction is received (“interrupt disable instruction, other” in step S220), the interrupt control device 2 returns to step S215.

When judging that the interrupt enable instruction is received (“interrupt enable instruction” in step S220), the interrupt control device 2 returns to step S200.

When judging that the state notification of the low power mode transition progress state is made (“state notification (low power mode transition progress state)” in step S220), the interrupt control device 2 maintains the power consumption mode (the normal mode), the interrupt state in the interrupt signal control unit 203 (the interrupt disable state), and the transition state in the low power mode transition control unit 205 (the transition permission state), and changes the operation state in the state management unit 204 to the low power mode transition progress state (step S225).

The interrupt control device 2 judges whether an instruction is received, a type of the received instruction, and whether an interrupt occurs, through condition judgment (step S230).

When judging that no interrupt occurs and no instruction is received (“other” in step S230), the interrupt control device 2 returns to step S225.

When judging that the interrupt enable instruction is received (“interrupt enable instruction” in step S230) the interrupt control device 2 returns to step S200.

When judging that the interrupt disable instruction is received (“interrupt disable instruction” in step S230), the interrupt control device 2 returns to step S215.

When judging that an interrupt occurs (“interrupt” in step S230), the interrupt control device 2 maintains the power consumption mode (the normal mode), the interrupt state in the interrupt signal control unit 203 (the interrupt disable state), and the operation state in the state operation unit 204 (the low power mode transition progress state), and changes the transition state in the low power mode transition control unit 205 to the transition prohibition state (step S235). The interrupt control device 2 judges whether an instruction is received, a type of the received instruction, and whether an interrupt occurs, through condition judgment (step S240). When judging that the interrupt enable instruction is received (“interrupt enable instruction” in step S240), the interrupt control device 2 returns to step S200. When judging that the interrupt disable instruction is received (“interrupt disable instruction” in step S240), the interrupt control device 2 returns to step S215. When judging that an interrupt occurs or that no interrupt occurs and no instruction is received (“interrupt, other” in step S240), the interrupt control device 2 returns to step S235. When judging that the low power mode switching instruction is received (“low power mode switching instruction” in step S240), the interrupt control device 2 maintains the power consumption mode (the normal mode), the operation state in the state management unit 204 (the low power mode transition progress state), and the transition state in the low power mode transition control unit 205 (the transition prohibition state), and changes the interrupt state in the interrupt signal control unit 203 to the interrupt enable state (step S245). The interrupt control device 2 then performs the interrupt handler process (step S250). The interrupt control device 2 maintains the power consumption mode (the normal mode) and the interrupt state in the interrupt signal control unit 203 (the interrupt enable state), and changes the operation state in the state management unit 204 to the normal operation state and the transition state in the low power mode transition control unit 205 to the transition permission state (step S255). The interrupt control device 2 then returns to step S205.

Meanwhile, when judging that the low power mode switching instruction is received (“low power mode switching instruction” in step S230), the interrupt control device 2 maintains the operation state in the state management unit 204 (the low power mode transition progress state) and the transition state in the low power mode transition control unit 205 (the transition permission state), and changes the power consumption mode to the low power mode and the interrupt state in the interrupt signal control unit 203 to the interrupt enable state (step S260). The interrupt control device 2 judges whether an instruction is received, a type of the received instruction, and whether an interrupt occurs, through condition judgment (step S265). When judging that the interrupt enable instruction is received or that no interrupt occurs and no instruction is received (“interrupt enable instruction, other” in step S265), the interrupt control device 2 returns to step S260. When judging that an interrupt occurs (“interrupt” in step S265), the interrupt control device 2 performs the interrupt handler process (step S270), and proceeds to step S255.

2.3. Specific Example

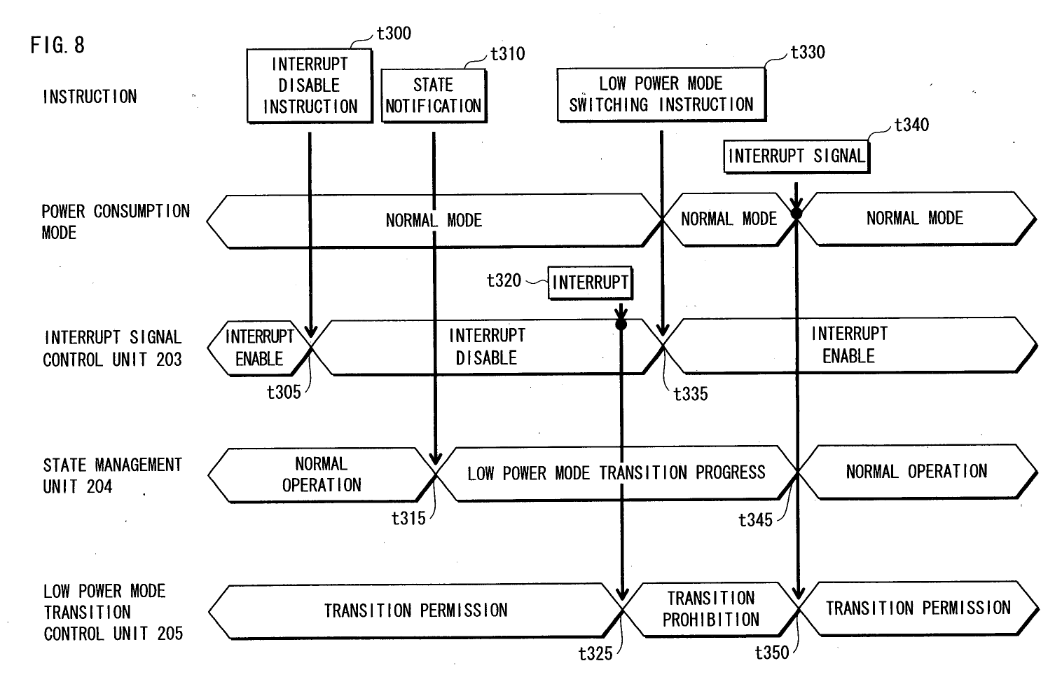

A specific operation of the interrupt control device 2 when an interrupt occurs in the low power mode transition progress state before the issuance of the low power mode switching instruction is described below, using a timing chart shown in FIG. 8.

When the microprocessor issues the interrupt disable instruction by executing the software (the transition procedure) (t300), the instruction decoding unit 200 notifies the low power mode instruction detection unit 201 and the interrupt enable/disable instruction detection unit 202 of the interrupt disable instruction.

Having received the interrupt disable instruction from the instruction decoding unit 200, the interrupt enable/disable instruction detection unit 202 notifies the interrupt signal control unit 203 of the reception of the interrupt disable instruction. Upon being notified of the interrupt disable instruction from the interrupt enable/disable instruction detection unit 202, the interrupt signal control unit 203 changes the interrupt state from the interrupt enable state to the interrupt disable state (t305).

The interrupt signal control unit 203 notifies the state management unit 204 of the low power mode transition progress state, as a state notification (t310).

Upon being notified of the low power mode transition progress state from the interrupt signal control unit 203, the state management unit 204 changes the operation state from the normal operation state to the low power mode transition progress state (t315). The state management unit 204 notifies the low power mode transition control unit 205 of the operation state.

When receiving an interrupt in the interrupt disable state (t320), the interrupt signal control unit 203 notifies the low power mode transition control unit 205 of the reception of the interrupt, and holds the received interrupt.

Upon being notified of the interrupt from the interrupt signal control unit 203, the low power mode transition control unit 205 judges whether the operation state notified by the state management unit 204 is the low power mode transition progress state. In this example, the low power mode transition control unit 205 judges that the operation state is the low power mode transition progress state, and changes the transition state from the transition permission state to the transition prohibition state (t325).

When the microprocessor issues the low power mode switching instruction by executing the software (the transition procedure) (t330), the instruction decoding unit 200 notifies the low power mode instruction detection unit 201 and the interrupt enable/disable instruction detection unit 202 of the low power mode switching instruction. The low power mode instruction detection unit 201 notifies the low power mode transition control unit 205 of the reception of the low power mode switching instruction. Upon being notified of the low power mode switching instruction from the low power mode instruction detection unit 201, the low power mode transition control unit 205 judges whether the current transition state is the transition permission state or the transition prohibition state. In this example, the low power mode transition control unit 205 judges that the current transition state is the transition prohibition state, notifies the interrupt signal control unit 203 of the reception of the low power mode switching instruction, and abandons the received low power mode switching instruction. Upon being notified of the low power mode switching instruction from the low power mode transition control unit 205, the interrupt signal control unit 203 changes the interrupt state from the interrupt disable state to the interrupt enable state (t335), and generates an interrupt signal for the held interrupt (t340).

The interrupt signal control unit 203 notifies the state management unit 204 and the low power mode transition control unit 205 of the generation of the interrupt signal. Upon being notified of the generation of the interrupt signal from the interrupt signal control unit 203, the state management unit 204 changes the operation state from the low power mode transition progress state to the normal operation state (t345). Upon being notified of the generation of the interrupt signal from the interrupt signal control unit 203, the low power mode transition control unit 205 changes the transition state from the transition prohibition state to the transition permission state (t350).

2.4. Modifications

Though the present invention has been described by way of the above second embodiment, the present invention should not be limited to the above. Example modifications are given below.

(1) The second embodiment describes the case where the low power mode transition control unit 205 manages whether to transition to the low power mode, through the use of the transition permission state and the transition prohibition state. However, the present invention is not limited to this.

For example, the management as to whether to transition to the low power mode may be made based on the operation state managed by the state management unit 204 and whether an interrupt is received or not.

In this case, when notified of the interrupt from the interrupt signal control unit 203, the low power mode transition control unit 205 judges whether the operation state notified from the state management unit 204 is the low power mode transition progress state. If the operation state is the low power mode transition progress state, the low power mode transition control unit 205 holds the interrupt notification. If the operation state is not the low power mode transition progress state, the low power mode transition control unit 205 abandons the interrupt notification.

Upon receiving the low power mode switching instruction from the low power mode instruction detection unit 201, the low power mode transition control unit 205 judges whether the interrupt notification is held. When judging that the interrupt notification is held, the low power mode transition control unit 205 notifies the interrupt signal control unit 203 of the reception of the low power mode switching instruction, and abandons the received low power mode switching instruction. In this case, the transition to the low power mode is not carried out. When notified of the generation of the interrupt signal from the interrupt signal control unit 203, the low power mode transition control unit 205 abandons the held interrupt notification.

When judging that the interrupt notification is not held, the low power mode transition control unit 205 notifies the low power mode control unit 206 to transition to the low power mode.

(2) The second embodiment describes the case where, when another interrupt occurs between t335 and t340 in FIG. 8 as one example, that interrupt is processed before the interrupt signal control unit 203 generates the interrupt signal for the interrupt received at t320, because interrupts are enabled during this period. However, the present invention is not limited to this.

For instance, the interrupt received at t320, i.e. the interrupt received in the interrupt disable state, is processed first and then another interrupt that occurs between t335 and t340 is processed. In such a case, if the interrupt signal control unit 203 receives another interrupt during the period from when interrupts become enabled to when the interrupt signal for the held interrupt is generated, the interrupt signal control unit 203 holds the received interrupt as an interrupt that follows the already held interrupt. Having done so, the interrupt signal control unit 203 generates the interrupt signal for the already held interrupt and then generates an interrupt signal for the following interrupt. In this way, the preceding interrupt can be processed first. An example operation of holding another interrupt as an interrupt that follows the already held interrupt is explained below. Upon receiving an interrupt, the interrupt signal control unit 203 judges whether any interrupt has already been held. If any interrupt has already been held, the interrupt signal control unit 203 holds the received interrupt as an interrupt that follows the already held interrupt. If there is no interrupt that has already been held, the interrupt signal control unit 203 generates an interrupt signal for the received interrupt.

Alternatively, another interrupt that occurs between t335 and t340 may be abandoned. In this case, if another interrupt is received during the period from when interrupts become enabled to when the interrupt signal for the held interrupt is generated, the interrupt signal control unit 203 abandons the received interrupt.

(3) The second embodiment and the above modifications can freely be combined.

2.5. Conclusion

According to the second embodiment described above, the interrupt control device 2 changes the operation state in accordance with the state notification by the interrupt signal control unit 203, in the low power mode transition procedure. If an interrupt is received in the low power mode transition progress state, the interrupt control device 2 suppresses an unwanted transition to the low power mode. As a result, a time for recovering from the low power mode can be saved.

Also, the low power mode switching instruction issued by the microprocessor executing the software (the transition procedure) can be used by the interrupt signal control unit 203 as the interrupt enable instruction. Which is to say, upon being notified of the low power mode switching instruction from the low power mode transition control unit 205 in the interrupt disable mode, the interrupt signal control unit 203 enables interrupts.

Also, the interrupt signal control unit 203 can suppress the generation of an interrupt signal for a received interrupt, until the low power mode switching instruction is received in the low power mode transition progress state.

### 3. Third Embodiment

The following describes an interrupt control device 3 as a third embodiment of the present invention.

3.1. Construction

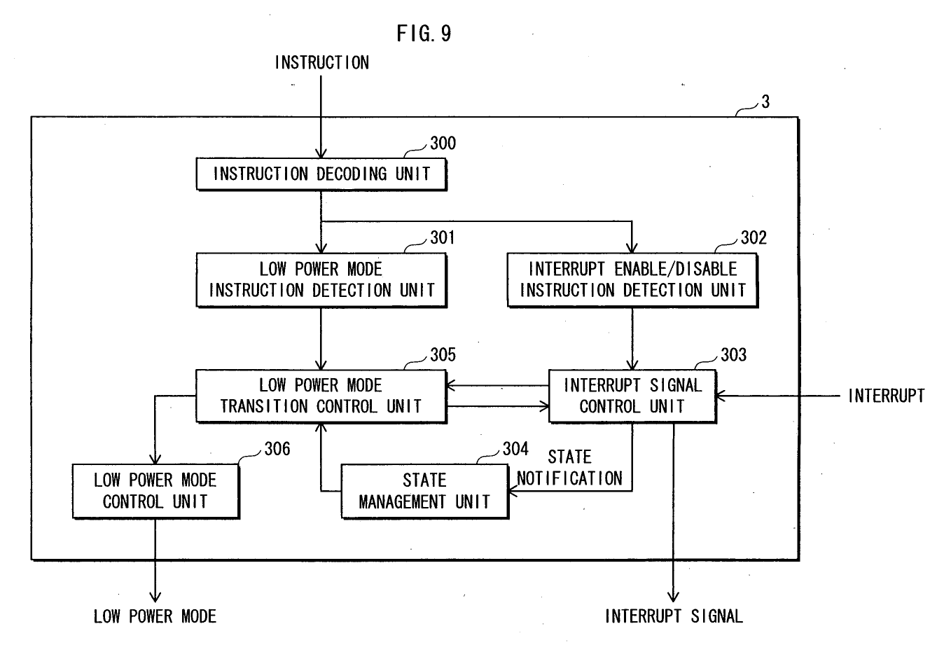

The interrupt control device 3 includes an instruction decoding unit 300, a low power mode instruction detection unit 301, an interrupt enable/disable instruction detection unit 302, an interrupt signal control unit 303, a state management unit 304, a low power mode transition control unit 305, and a low power mode control unit 306, as shown in FIG. 9.

The following explains each construction element in the case where a microprocessor decides to enter a low power mode as a result of software execution.

Upon deciding to enter the low power mode, the microprocessor performs a procedure to transition to the low power mode, by executing software. By performing the low power mode transition procedure, the microprocessor issues an interrupt disable instruction to disable interrupts, an interrupt enable instruction to enable interrupts, and a low power mode switching instruction to change a power consumption mode from a normal power mode (hereafter “normal mode”) to the low power mode, to the interrupt control device 3.

(1) Instruction Decoding Unit 300

The instruction decoding unit 300 receives an instruction issued by the microprocessor executing the software (the transition procedure), decodes the received instruction, and outputs a decoding result to the low power mode instruction detection unit 301 and the interrupt enable/disable instruction detection unit 302.

(2) Low Power Mode Instruction Detection Unit 301

The low power mode instruction detection unit 301 receives the decoding result from the instruction decoding unit 300, and judges whether the received decoding result is the low power mode switching instruction.

If the received decoding result is judged to be the low power mode switching instruction, the low power mode instruction detection unit 301 notifies the low power mode transition control unit 305 of the reception of the low power mode switching instruction.

If the received decoding result is judged to be not the low power mode switching instruction, the low power mode instruction detection unit 301 abandons the received decoding result.

(3) Interrupt Enable/Disable Instruction Detection Unit 302

The interrupt enable/disable instruction detection unit 302 receives the decoding result from the instruction decoding unit 300, and judges whether the received decoding result is any of the interrupt disable instruction and the interrupt enable instruction.

If the received decoding result is judged to be the interrupt disable instruction, the interrupt enable/disable instruction detection unit 302 notifies the interrupt signal control unit 303 of the reception of the interrupt disable instruction.

If the received decoding result is judged to be the interrupt enable instruction, the interrupt enable/disable instruction detection unit 302 notifies the interrupt signal control unit 303 of the reception of the interrupt enable instruction.

If the received decoding result is neither the interrupt disable instruction nor the interrupt enable instruction, the interrupt enable/disable instruction detection unit 302 abandons the received decoding result.

(4) Interrupt Signal Control Unit 303

The interrupt signal control unit 303 disables interrupts, upon being notified of the reception of the interrupt disable instruction from the interrupt enable/disable instruction detection unit 302. The interrupt signal control unit 303 then notifies the state management unit 304 of a low power mode transition progress state where the transition to the low power mode is in progress, as a state notification.

The interrupt signal control unit 303 enables interrupts, upon being notified of the reception of the interrupt enable instruction from the interrupt enable/disable instruction detection unit 302.

(When Interrupts are Disabled)

When receiving an interrupt (e.g. an external interrupt) in the interrupt disable state, the interrupt signal control unit 303 notifies the low power mode transition control unit 305 of the reception of the interrupt, and holds the received interrupt. Upon being notified of the low power mode switching instruction from the low power mode transition control unit 305, the interrupt signal control unit 303 enables interrupts, generates an interrupt signal for the held interrupt, and starts an interrupt handler process. The interrupt signal control unit 303 notifies the state management unit 304 and the low power mode transition control unit 305 of the generation of the interrupt signal for the held interrupt. In this case, the interrupt is processed by an external device.

Upon receiving an abandonment instruction to abandon the interrupt from the low power mode transition control unit 305, the interrupt signal control unit 303 abandons the held interrupt.

(When Interrupts are Enabled)

When receiving an interrupt in the interrupt enable state, the interrupt signal control unit 303 generates an interrupt signal for the received interrupt, and starts the interrupt handler process. In this case, the interrupt is processed by the external device.

(5) State Management Unit 304

The state management unit 304 manages (holds) an operation state, and notifies the low power mode transition control unit 305 of the managed operation state. The operation state managed by the state management unit 304 is any of the normal operation state and the low power mode transition progress state, as in the case of the state management unit 204 in the second embodiment.

When notified of the low power mode transition progress state from the interrupt signal control unit 303, the state management unit 304 sets the operation state to the low power mode transition progress state, and notifies the low power mode transition control unit 305 of the operation state.

When notified of the generation of the interrupt signal from the interrupt signal control unit 303, the state management unit 304 sets the operation state to the normal operation state, and notifies the low power mode transition control unit 305 of the operation state.

(6) Low Power Mode Transition Control Unit 305

The low power mode transition control unit 305 manages a state of transitioning to the low power mode, in two states that are a complete transition state and a partial transition state. The complete transition state indicates that the transition from the normal mode to the low power mode is performed by stopping all clocks of an external main device (e.g. a CPU) and peripheral device (e.g. a serial port, a USB, an SD card). The partial transition mode indicates that the transition from the normal mode to the low power mode is performed by stopping only the clock of the peripheral device (e.g. a serial port, a USB, an SD card).

The low power mode transition control unit 305 initially sets the complete transition state.

Upon being notified of the reception of the interrupt from the interrupt signal control unit 303, the low power mode transition control unit 305 judges whether the operation state notified by the state management unit 304 is the low power mode transition progress state. If the operation state is judged to be the low power mode transition progress state, the low power mode transition control unit 305 changes the transition state from the complete transition state to the partial transition state. If the operation state is judged to be not the low power mode transition progress state, the low power mode transition control unit 305 only outputs the abandonment instruction to the interrupt signal control unit 303, and does not change the transition state.

Upon receiving the low power mode switching instruction from the low power mode instruction detection unit 301, the low power mode transition control unit 305 judges whether the current transition state is the complete transition state or the partial transition state.

If the current transition state is judged to be the partial transition state, the low power mode transition control unit 305 notifies the low power mode control unit 306 to transition to the low power mode by stopping the clock of the peripheral device (hereafter “first transition instruction”). The low power mode transition control unit 305 also notifies the interrupt signal control unit 303 of the reception of the low power mode switching instruction. After this, when notified of the generation of the interrupt signal from the interrupt signal control unit 303, the low power mode transition control unit 305 changes the transition state from the partial transition state to the complete transition state. The low power mode transition control unit 305 also notifies the low power mode control unit 306 to start the clock of the peripheral device.

If the transition state is judged to be the complete transition state, the low power mode transition control unit 305 notifies the low power mode control unit 306 to transition to the low power mode by stopping all of the clocks of the external main device and peripheral device (hereafter, “second transition instruction”).

(7) Low Power Mode Control Unit 306

The low power mode control unit 306 generates the low power mode by stopping the clock of the peripheral device, upon receiving the first transition instruction from the low power mode transition control unit 305.

The low power mode control unit 306 generates the low power mode by stopping all of the clocks of the external main device and peripheral device, upon receiving the second transition instruction from the low power mode transition control unit 305.

When notified to start the clock of the peripheral device from the low power mode transition control unit 305, the low power mode control unit 306 starts the clock of the peripheral device, to change the power consumption mode from the low power mode to the normal mode.

3.2. Operation

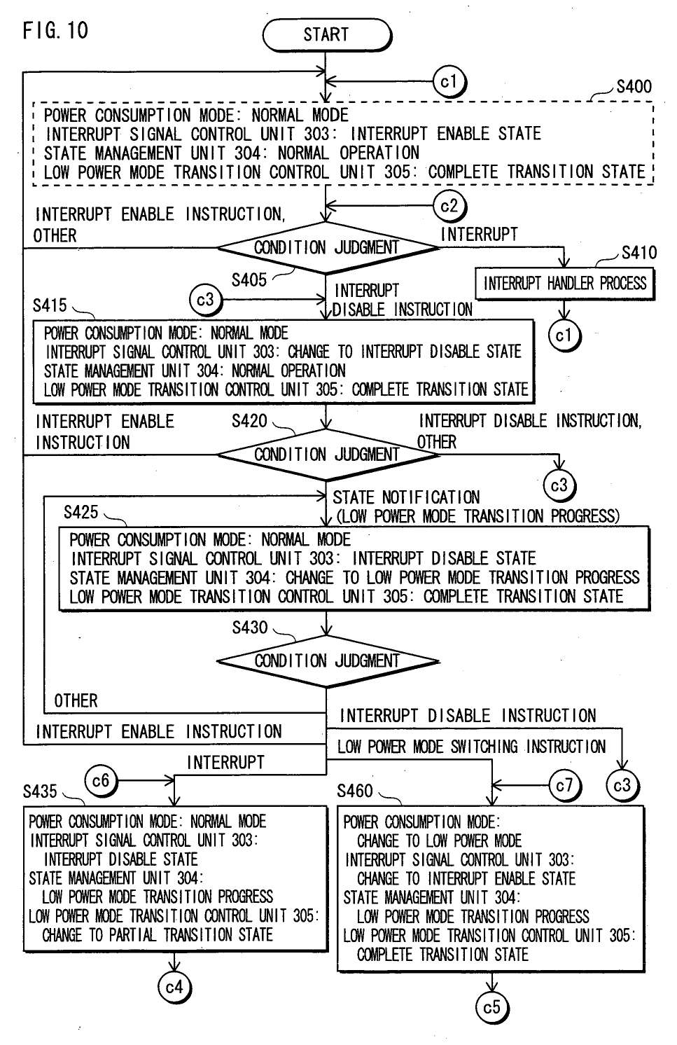

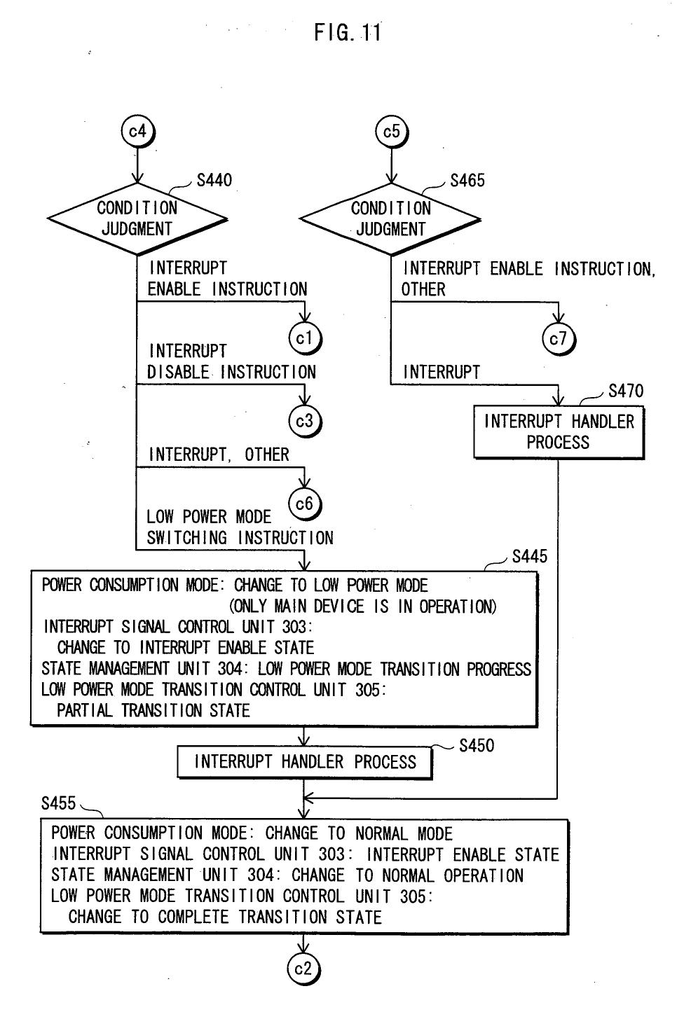

An operation of the interrupt control device 3 is described below, using flowcharts shown in FIGS. 10 and 11.

The interrupt control device 3 sets the power consumption mode to the normal mode, the interrupt state managed by the interrupt signal control unit 303 to the interrupt enable state, the operation state managed by the state management unit 304 to the normal operation state, and the transition state managed by the low power mode transition control unit 305 to the complete transition state (step S400).

The interrupt control device 3 judges whether an instruction is received, a type of the received instruction, and whether an interrupt occurs, through condition judgment (step S405).

When judging that an interrupt occurs (“interrupt” in step S405), the interrupt control device 3 performs the interrupt handler process (step S410) and returns to step S400.

When judging that the interrupt enable instruction is received or that no interrupt occurs and no instruction is received (“interrupt enable instruction, other” in step S405), the interrupt control device 3 returns to step S400.

When judging that the interrupt disable instruction is received (“interrupt disable instruction” in step S405), the interrupt control device 3 maintains the power consumption mode (the normal mode), the operation state in the state management unit 304 (the normal operation state), and the transition state in the low power mode transition control unit 305 (the complete transition state), and changes the interrupt state in the interrupt signal control unit 303 to the interrupt disable state (step S415).

The interrupt control device 3 judges whether an instruction is received, a type of the received instruction, and whether an interrupt occurs, through condition judgment (step S420).

When judging that the interrupt disable instruction is received or that no interrupt occurs and no instruction is received (“interrupt disable instruction, other” in step S420), the interrupt control device 3 returns to step S415.

When judging that the interrupt enable instruction is received (“interrupt enable instruction” in step S420) the interrupt control device 3 returns to step S400.

When judging that the low power mode transition progress state is notified as the state notification (“state notification (low power mode transition progress)” in step S420), the interrupt control device 3 maintains the power consumption mode (the normal mode) the interrupt state in the interrupt signal control unit 303 (the interrupt disable state), and the transition state in the low power mode transition control unit 305 (the complete transition state), and changes the operation state in the state management unit 304 to the low power mode transition progress state (step S425).

The interrupt control device 3 judges whether an instruction is received, a type of the received instruction, and whether an interrupt occurs, through condition judgment (step S430).

When judging that no interrupt occurs and no instruction is received (“other” in step S430), the interrupt control device 3 returns to step S425.

When judging that the interrupt enable instruction is received (“interrupt enable instruction” in step S430) the interrupt control device 3 returns to step S400.

When judging that the interrupt disable instruction is received (“interrupt disable instruction” in step S430), the interrupt control device 3 returns to step S415.

When judging that an interrupt occurs (“interrupt” in step S430), the interrupt control device 3 maintains the power consumption mode (the normal mode), the interrupt state in the interrupt signal control unit 303 (the interrupt disable state), and the operation state in the state operation unit 304 (the low power mode transition progress state), and changes the transition state in the low power mode transition control unit 305 to the partial transition state (step S435). The interrupt control device 3 judges whether an instruction is received, a type of the received instruction, and whether an interrupt occurs, through condition judgment (step S440). When judging that the interrupt enable instruction is received (“interrupt enable instruction” in step S440), the interrupt control device 3 returns to step S400. When judging that the interrupt disable instruction is received (“interrupt disable instruction” in step S440), the interrupt control device 3 returns to step S415. When judging that an interrupt occurs or that no interrupt occurs and no instruction is received (“interrupt, other” in step S440), the interrupt control device 3 returns to step S435. When judging that the low power mode switching instruction is received (“low power mode switching instruction” in step S440), the interrupt control device 3 maintains the operation state in the state management unit 304 (the low power mode transition progress state) and the transition state in the low power mode transition control unit 305 (the partial transition state), and changes the power consumption mode to the low power mode (only the main device is in operation) and the interrupt state in the interrupt signal control unit 303 to the interrupt enable state (step S445). The interrupt control device 3 then performs the interrupt handler process (step S450). The interrupt control device 3 maintains the interrupt state in the interrupt signal control unit 303 (the interrupt enable state), and changes the power consumption mode to the normal mode, the operation state in the state management unit 304 to the normal operation state, and the transition state in the low power mode transition control unit 305 to the complete transition state (step S455). The interrupt control device 3 then returns to step S405.

Meanwhile, when judging that the low power mode switching instruction is received (“low power mode switching instruction” in step S430), the interrupt control device 3 maintains the operation state in the state management unit 304 (the low power mode transition progress state) and the transition state in the low power mode transition control unit 305 (the complete transition state), and changes the power consumption mode to the low power mode and the interrupt state in the interrupt signal control unit 303 to the interrupt enable state (step S460). The interrupt control device 3 judges whether an instruction is received, a type of the received instruction, and whether an interrupt occurs, through condition judgment (step S465). When judging that the interrupt enable instruction is received or that no interrupt occurs and no instruction is received (“interrupt enable instruction, other” in step S465), the interrupt control device 3 returns to step S460. When judging that an interrupt occurs (“interrupt” in step S465), the interrupt control device 3 performs the interrupt handler process (step S470), and proceeds to step S455.

3.3. Specific Example

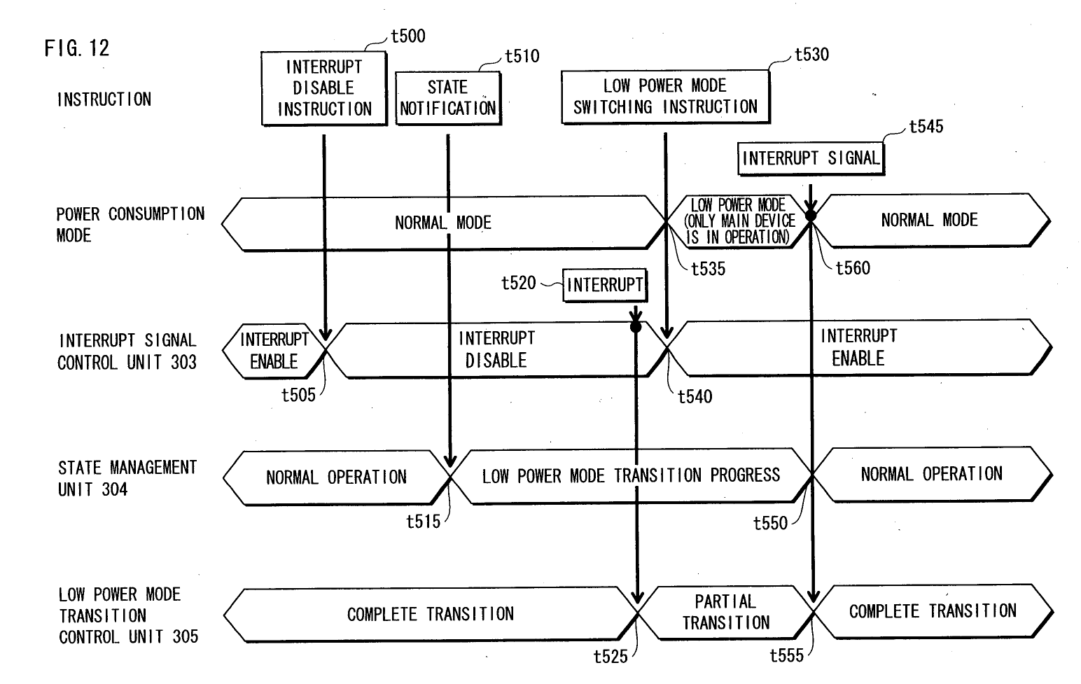

A specific operation of the interrupt control device 3 when an interrupt occurs in the low power mode transition progress state before the issuance of the low power mode switching instruction is described below, using a timing chart shown in FIG. 12.

When the microprocessor issues the interrupt disable instruction by executing the software (the transition procedure) (t500), the instruction decoding unit 300 notifies the low power mode instruction detection unit 301 and the interrupt enable/disable instruction detection unit 302 of the interrupt disable instruction.

Having received the interrupt disable instruction from the instruction decoding unit 300, the interrupt enable/disable instruction detection unit 302 notifies the interrupt signal control unit 303 of the reception of the interrupt disable instruction. Upon being notified of the interrupt disable instruction from the interrupt enable/disable instruction detection unit 302, the interrupt signal control unit 303 changes the interrupt state from the interrupt enable state to the interrupt disable state (t505).

The interrupt signal control unit 303 notifies the state management unit 304 of the low power mode transition progress state, as a state notification (t510).

Upon being notified of the low power mode transition progress state from the interrupt signal control unit 303, the state management unit 304 changes the operation state from the normal operation state to the low power mode transition progress state (t515). The state management unit 304 notifies the low power mode transition control unit 305 of the operation state.

When receiving an interrupt in the interrupt disable state (t520), the interrupt signal control unit 303 notifies the low power mode transition control unit 305 of the reception of the interrupt, and holds the received interrupt.

Upon being notified of the interrupt from the interrupt signal control unit 303, the low power mode transition control unit 305 judges whether the operation state notified by the state management unit 304 is the low power mode transition progress state. In this example, the low power mode transition control unit 305 judges that the operation state is the low power mode transition progress state, and changes the transition state from the complete transition state to the partial transition state (t525).

When the microprocessor issues the low power mode switching instruction by executing the software (the transition procedure) (t530), the instruction decoding unit 300 notifies the low power mode instruction detection unit 301 and the interrupt enable/disable instruction detection unit 302 of the low power mode switching instruction. The low power mode instruction detection unit 301 notifies the low power mode transition control unit 305 of the reception of the low power mode switching instruction. Upon being notified of the low power mode switching instruction from the low power mode instruction detection unit 301, the low power mode transition control unit 305 judges whether the current transition state is the complete transition state or the partial transition state. In this example, the low power mode transition control unit 305 judges that the current transition state is the partial transition state, and outputs the first transition instruction to the low power mode control unit 306. Upon receiving the first transition instruction from the low power mode transition control unit 305, the low power mode control unit 306 changes the power consumption mode from the normal mode to the low power mode (only the main device is in operation) (t535). Here, the low power mode control unit 306 generates the low power mode (only the main device operates by clock), by stopping the clock of the peripheral device.

The low power mode transition control unit 305 also notifies the interrupt signal control unit 303 of the reception of the low power mode switching instruction. Upon being notified of the low power mode switching instruction from the low power mode transition control unit 305, the interrupt signal control unit 303 changes the interrupt state from the interrupt disable state to the interrupt enable state (t540), and generates an interrupt signal for the held interrupt (t545).

The interrupt signal control unit 303 notifies the state management unit 304 and the low power mode transition control unit 305 of the generation of the interrupt signal. Upon being notified of the generation of the interrupt signal from the interrupt signal control unit 303, the state management unit 304 changes the operation state from the low power mode transition progress state to the normal operation state (t550). Upon being notified of the generation of the interrupt signal from the interrupt signal control unit 303, the low power mode transition control unit 305 changes the transition state from the partial transition state to the complete transition state (t555). The low power mode transition control unit 305 also notifies the low power mode control unit 306 to start the clock of the peripheral device. When notified to start the clock of the peripheral device from the low power mode transition control unit 305, the low power mode control unit 306 starts the clock of the peripheral device, to change the power consumption mode from the low power mode to the normal mode (t560).

3.4. Modifications

Though the present invention has been described by way of the above third embodiment, the present invention should not be limited to the above. Example modifications are given below.

(1) The third embodiment describes the case where the low power mode transition control unit 305 manages whether to completely or partially transition to the low power mode, through the use of the complete transition state and the partial transition state. However, the present invention is not limited to this.

For example, the management as to whether to completely or partially transition to the low power mode may be made based on the operation state managed by the state management unit 304 and whether an interrupt is received or not.

In such a case, upon being notified of the interrupt from the interrupt signal control unit 303, the low power mode transition control unit 305 judges whether the operation state notified from the state management unit 304 is the low power mode transition progress state. If the operation state is judged to be the low power mode transition progress state, the low power mode transition control unit 305 holds the interrupt notification. If the operation state is judged to be not the low power mode transition progress state, the low power mode transition control unit 305 abandons the interrupt notification.

Upon receiving the low power mode switching instruction from the low power mode instruction detection unit 301, the low power mode transition control unit 305 judges whether the interrupt notification is held. When judging that the interrupt notification is held, the low power mode transition control unit 305 notifies the interrupt signal control unit 303 of the reception of the low power mode switching instruction, and abandons the received low power mode switching instruction. In this case, the transition to the low power mode is not carried out. Upon being notified of the generation of the interrupt signal from the interrupt signal control unit 303, the low power mode transition control unit 305 abandons the held interrupt notification.

When judging that the interrupt notification is not held, the low power mode transition control unit 305 notifies the low power mode control unit 306 to transition to the low power mode.

(2) The third embodiment describes the case where, when another interrupt occurs between t540 and t545 in FIG. 12 as one example, that interrupt is processed before the interrupt signal control unit 303 generates the interrupt signal for the interrupt received at t520, because interrupts are enabled during this period. However, the present invention is not limited to this.

For instance, the interrupt received at t520, i.e. the interrupt received in the interrupt disable state, is processed first and then another interrupt that occurs between t540 and t545 is processed. In such a case, if another interrupt is received during the period from when interrupts become enabled to when the interrupt signal for the held interrupt is generated, the interrupt signal control unit 303 holds the received interrupt as an interrupt that follows the already held interrupt. Having done so, the interrupt signal control unit 303 generates the interrupt signal for the already held interrupt and then generates an interrupt signal for the following interrupt. In this way, the preceding interrupt can be processed first. An example operation of holding another interrupt as an interrupt that follows the already held interrupt is explained below. When receiving an interrupt, the interrupt signal control unit 303 judges whether any interrupt has already been held. If there is any interrupt that has already been held, the interrupt signal control unit 303 holds the received interrupt as an interrupt that follows the already held interrupt. If there is no interrupt that has already been held, the interrupt signal control unit 303 generates an interrupt signal for the received interrupt.

Alternatively, another interrupt that occurs between t540 and t545 may be abandoned. In this case, if another interrupt is received during the period from when interrupts become enabled to when the interrupt signal for the held interrupt is generated, the interrupt signal control unit 303 abandons the received interrupt.

(3) The third embodiment and the above modifications can freely be combined.

3.5. Conclusion

According to the third embodiment described above, the interrupt control device 3 changes the state in accordance with the state notification by the interrupt signal control unit 303, in the low power mode transition procedure. If an interrupt is received in the low power mode transition progress state, the interrupt control device 3 makes the partial transition to the low power mode. As a result, a time for recovering from the low power mode can be reduced.

Also, the low power mode switching instruction issued by the microprocessor executing the software (the transition procedure) can be used by the interrupt signal control unit 303 as the interrupt enable instruction. Which is to say, upon being notified of the low power mode switching instruction from the low power mode transition control unit 305 in the interrupt disable state, the interrupt signal control unit 303 enables interrupts.

Also, the interrupt signal control unit 303 can suppress the generation of an interrupt signal for a received interrupt, until the low power mode switching instruction is received in the low power mode transition progress state.

### 4. Fourth Embodiment

The following describes an interrupt control device 4 as a fourth embodiment of the present invention.

4.1. Construction

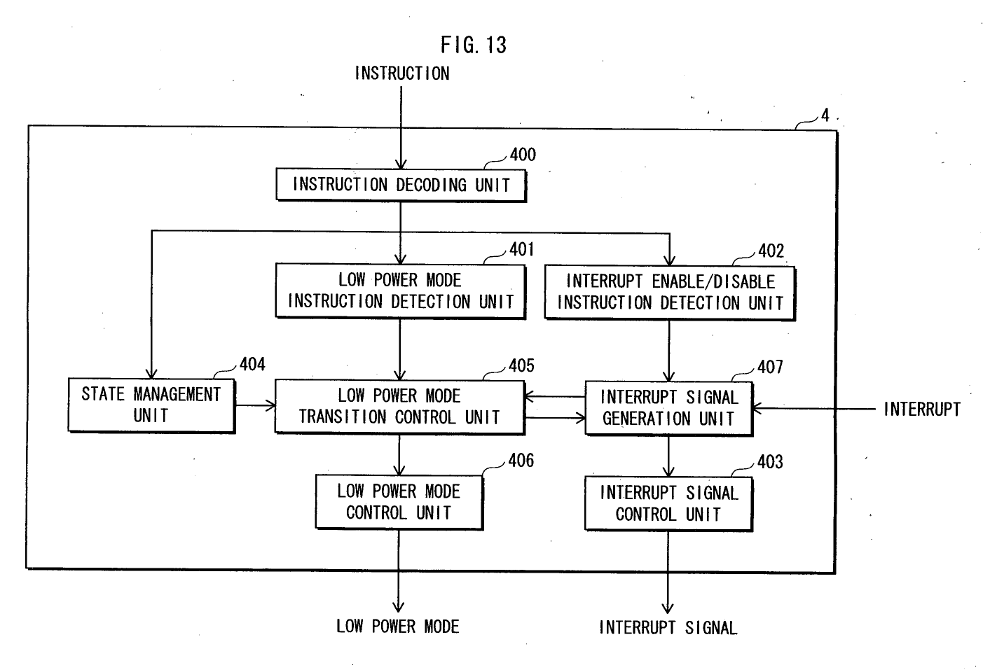

The interrupt control device 4 includes an instruction decoding unit 400, a low power mode instruction detection unit 401, an interrupt enable/disable instruction detection unit 402, an interrupt signal control unit 403, a state management unit 404, a low power mode transition control unit 405, a low power mode control unit 406, and an interrupt signal generation unit 407, as shown in FIG. 13.

The following explains each construction element in the case where a microprocessor decides to enter a low power mode as a result of software execution.

Upon deciding to enter the low power mode, the microprocessor performs a procedure to transition to the low power mode by executing software. By performing the low power mode transition procedure, the microprocessor issues an interrupt disable instruction to disable interrupts, an interrupt enable instruction to enable interrupts, a low power mode switching instruction to change a power consumption mode from a normal power mode (hereafter “normal mode”) to the low power mode, a normal operation instruction indicating that the microprocessor is operating in the normal mode, and a low power mode transition progress instruction indicating that the microprocessor is transitioning to the low power mode, to the interrupt control device 4.

(1) Instruction Decoding Unit 400

The instruction decoding unit 400 receives an instruction issued by the microprocessor executing the software (the transition procedure), decodes the received instruction, and outputs a decoding result to the low power mode instruction detection unit 401, the interrupt enable/disable instruction detection unit 402, and the state management unit 404.

(2) Low Power Mode Instruction Detection Unit 401

The low power mode instruction detection unit 401 receives the decoding result from the instruction decoding unit 400, and judges whether the received decoding result is the low power mode switching instruction.

If the received decoding result is judged to be the low power mode switching instruction, the low power mode instruction detection unit 401 notifies the low power mode transition control unit 405 of the reception of the low power mode switching instruction.

If the received decoding result is judged to be not the low power mode switching instruction, the low power mode instruction detection unit 401 abandons the received decoding result.

(3) Interrupt Enable/Disable Instruction Detection Unit 402

The interrupt enable/disable instruction detection unit 402 receives the decoding result from the instruction decoding unit 400, and judges whether the received decoding result is any of the interrupt disable instruction and the interrupt enable instruction.

If the received decoding result is judged to be the interrupt disable instruction, the interrupt enable/disable instruction detection unit 402 notifies the interrupt signal generation unit 407 of the reception of the interrupt disable instruction.

If the received decoding result is judged to be the interrupt enable instruction, the interrupt enable/disable instruction detection unit 402 notifies the interrupt signal generation unit 407 of the reception of the interrupt enable instruction.

If the received decoding result is neither the interrupt disable instruction nor the interrupt enable instruction, the interrupt enable/disable instruction detection unit 402 abandons the received decoding result.

(4) Interrupt Signal Generation Unit 407

The interrupt signal generation unit 407 disables interrupts, when notified of the reception of the interrupt disable instruction from the interrupt enable/disable instruction detection unit 402.

The interrupt signal generation unit 407 enables interrupts, when notified of the reception of the interrupt enable instruction from the interrupt enable/disable instruction detection unit 402.

(When Interrupts are Disabled)

When receiving an interrupt (e.g. an external interrupt) in the interrupt disable state, the interrupt signal generation unit 407 notifies the low power mode transition control unit 405 of the reception of the interrupt, and abandons the received interrupt. Upon being notified of the low power mode switching instruction from the low power mode transition control unit 405, the interrupt signal generation unit 407 enables interrupts.

(When Interrupts are Enabled)

When receiving an interrupt in the interrupt enable state, the interrupt signal generation unit 407 notifies the interrupt signal control unit 403 of the received interrupt.

(5) Interrupt Signal Control Unit 403

The interrupt signal control unit 403 generates, upon receiving the interrupt from the interrupt signal generation unit 407, an interrupt signal for the received interrupt, and starts an interrupt handler process. In this case, the interrupt is processed by an external device.

(6) State Management Unit 404

The state management unit 404 manages (holds) an operation state, and notifies the low power mode transition control unit 405 of the managed operation state. The operation state managed by the state management unit 404 is any of the normal operation state and the low power mode transition progress state, as in the case of the state management unit 204 in the second embodiment.

Upon receiving the decoding result from the instruction decoding unit 400, the state management unit 404 judges whether the received decoding result is any of the normal operation instruction and the low power mode transition progress instruction.

When judging that the decoding result is the low power mode transition progress instruction, the state management unit 404 sets the operation state to the low power mode transition progress state, and notifies the low power mode transition control unit 405 of the operation state.

When judging that the decoding result is the normal operation instruction, the state management unit 404 sets the operation state to the normal operation state, and notifies the low power mode transition control unit 405 of the operation state.

If the decoding result is neither the low power mode transition progress instruction nor the normal operation instruction, the state management unit 404 abandons the received decoding result.

(7) Low Power Mode Transition Control Unit 405

The low power mode transition control unit 405 manages a transition state as to whether to transition to the low power mode, in two states. The two states are a transition permission state where the transition to the low power mode is permitted, and a transition prohibition state where the transition to the low power mode is prohibited.

The low power mode transition control unit 405 initially sets the transition permission state.

Upon being notified of the interrupt from the interrupt signal generation unit 407, the low power mode transition control unit 405 judges whether the operation state notified by the state management unit 404 is the low power mode transition progress state. If the operation state is judged to be the low power mode transition progress state, the low power mode transition control unit 405 changes the transition state from the transition permission state to the transition prohibition state. If the operation state is judged to be not the low power mode transition progress state, the low power mode transition control unit 405 does not change the transition state.

Upon receiving the low power mode switching instruction from the low power mode instruction detection unit 401, the low power mode transition control unit 405 judges whether the current transition state is the transition permission state or the transition prohibition state.

If the current transition state is judged to be the transition prohibition state, the low power mode transition control unit 405 notifies the interrupt signal generation unit 407 of the reception of the low power mode switching instruction, and abandons the received low power mode switching instruction. In this case, the transition to the low power mode is not carried out.

If the current transition state is judged to be the transition permission state, the low power mode transition control unit 405 notifies the low power mode control unit 406 to transition to the low power mode.

Also, when notified of the normal operation state from the state management unit 404 as a state notification, the low power mode transition control unit 405 judges whether the current transition state is the transition permission state or the transition prohibition state. If the current transition state is judged to be the transition prohibition state, the low power mode transition control unit 405 changes the transition state from the transition prohibition state to the transition permission state. If the current transition state is judged to be the transition permission state, the low power mode transition control unit 405 does not perform any operation.

(8) Low Power Mode Control Unit 406

The low power mode control unit 406 generates the low power mode, when notified to transition to the low power mode from the low power mode transition control unit 405. As a result, clocks of an external main device (e.g. a CPU) and peripheral device (e.g. a serial port, a USB, an SD card) are stopped to have the microprocessor enter the low power mode.

4.2. Operation

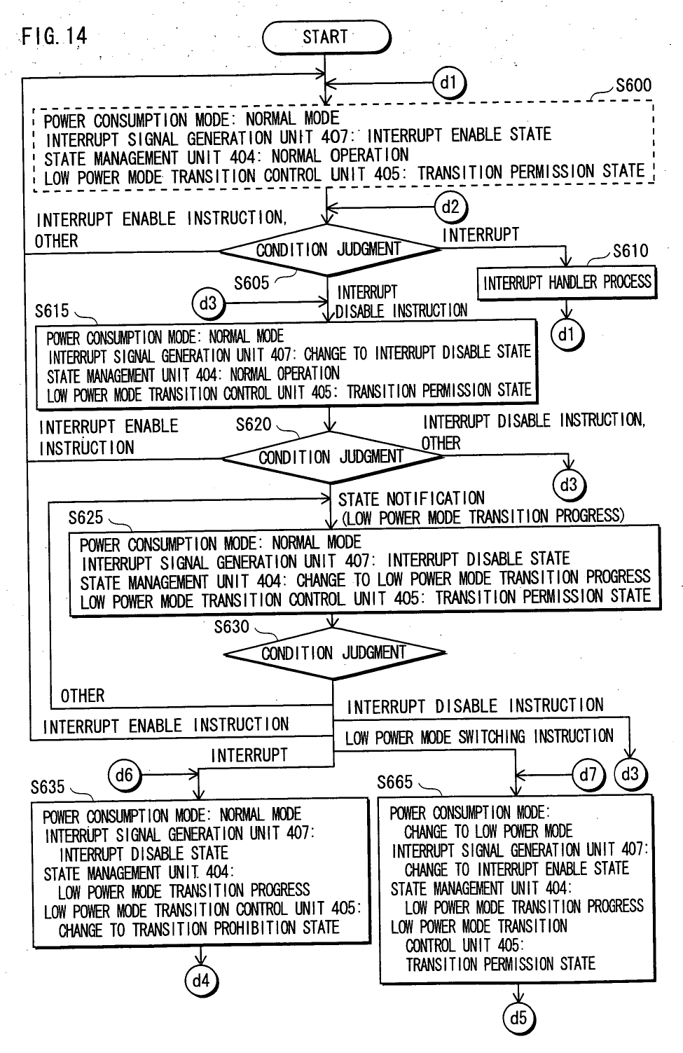

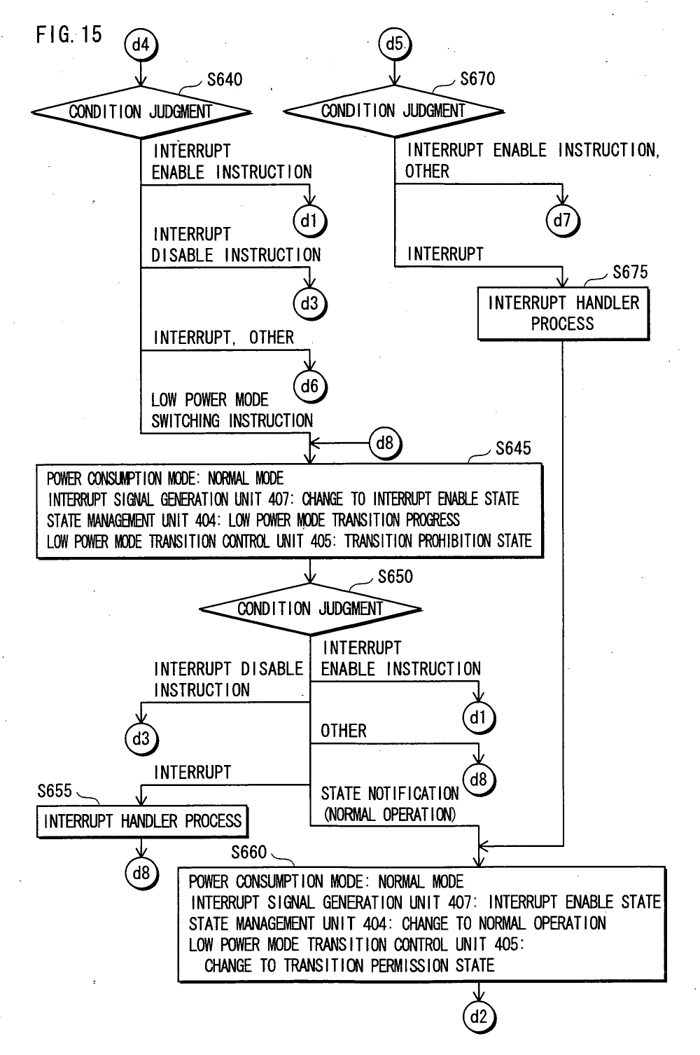

An operation of the interrupt control device 4 is described below, using flowcharts shown in FIGS. 14 and 15.

The interrupt control device 4 sets the power consumption mode to the normal mode, the interrupt state managed by the interrupt signal generation unit 407 to the interrupt enable state, the operation state managed by the state management unit 404 to the normal operation state, and the transition state managed by the low power mode transition control unit 405 to the transition permission state (step S600).

The interrupt control device 4 judges whether an instruction is received, a type of the received instruction, and whether an interrupt occurs, through condition judgment (step S605).

When judging that an interrupt occurs (“interrupt” in step S605), the interrupt control device 4 performs the interrupt handler process (step S610) and returns to step S600.

When judging that the interrupt enable instruction is received or that no interrupt occurs and no instruction is received (“interrupt enable instruction, other” in step S605), the interrupt control device 4 returns to step S600.

When judging that the interrupt disable instruction is received (“interrupt disable instruction” in step S605), the interrupt control device 4 maintains the power consumption mode (the normal mode), the operation state in the state management unit 404 (the normal operation state), and the transition state in the low power mode transition control unit 405 (the transition permission state), and changes the interrupt state in the interrupt signal generation unit 407 to the interrupt disable state (step S615).

The interrupt control device 4 judges whether an instruction is received, a type of the received instruction, and whether an interrupt occurs, through condition judgment (step S620).

When judging that the interrupt disable instruction is received or that no interrupt occurs and no instruction is received (“interrupt disable instruction, other” in step S620), the interrupt control device 4 returns to step S615.

When judging that the interrupt enable instruction is received (“interrupt enable instruction” in step S620) the interrupt control device 4 returns to step S600.

When judging that the low power mode transition progress instruction is received (“state notification (low power mode transition progress)” in step S620), the interrupt control device 4 maintains the power consumption mode (the normal mode), the interrupt state in the interrupt signal generation unit 407 (the interrupt disable state), and the transition state in the low power mode transition control unit 405 (the transition permission state), and changes the operation state in the state management unit 404 to the low power mode transition progress state (step S625).

The interrupt control device 4 judges whether an instruction is received, a type of the received instruction, and whether an interrupt occurs, through condition judgment (step S630).

When judging that no interrupt occurs and no instruction is received (“other” in step S630), the interrupt control device 4 returns to step S625.

When judging that the interrupt enable instruction is received (“interrupt enable instruction” in step S630) the interrupt control device 4 returns to step S600.

When judging that the interrupt disable instruction is received (“interrupt disable instruction” in step S630), the interrupt control device 4 returns to step S615.

When judging that an interrupt occurs (“interrupt” in step S630), the interrupt control device 4 maintains the power consumption mode (the normal mode), the interrupt state in the interrupt signal generation unit 407 (the interrupt disable state), and the operation state in the state operation unit 404 (the low power mode transition progress state), and changes the transition state in the low power mode transition control unit 405 to the transition prohibition state (step S635). The interrupt control device 4 judges whether an instruction is received, a type of the received instruction, and whether an interrupt occurs, through condition judgment (step S640). When judging that the interrupt enable instruction is received (“interrupt enable instruction” in step S640), the interrupt control device 4 returns to step S600. When judging that the interrupt disable instruction is received (“interrupt disable instruction” in step S640), the interrupt control device 4 returns to step S615. When judging that an interrupt occurs or that no interrupt occurs and no instruction is received (“interrupt, other” in step S640), the interrupt control device 4 returns to step S635. When judging that the low power mode switching instruction is received (“low power mode switching instruction” in step S640), the interrupt control device 4 maintains the power consumption mode (the normal mode), the operation state in the state management unit 404 (the low power mode transition progress state), and the transition state in the low power mode transition control unit 405 (the transition prohibition state), and changes the interrupt state in the interrupt signal generation unit 407 to the interrupt enable state (step S645).

The interrupt control device 4 judges whether an instruction is received, a type of the received instruction, and whether an interrupt occurs, through condition judgment (step S650). When judging that the interrupt enable instruction is received (“interrupt enable instruction” in step S650), the interrupt control device 4 returns to step S600. When judging that the interrupt disable instruction is received (“interrupt disable instruction” in step S650), the interrupt control device 4 returns to step S615. When judging that no interrupt occurs and no instruction is received (“other” in step S650), the interrupt control device 4 returns to step S645. When judging that an interrupt occurs (“interrupt” in step S650), the interrupt control device 4 performs the interrupt handler process (step S655), and returns to step S645. When judging that the normal operation instruction is received (“state notification (normal operation)” in step S650), the interrupt control device 4 maintains the power consumption mode (the normal mode) and the interrupt state in the interrupt signal generation unit 407 (the interrupt enable state), and changes the operation state in the state management unit 404 to the normal operation state and the transition state in the low power mode transition control unit 405 to the transition permission state (step S660).

Meanwhile, when judging that the low power mode switching instruction is received (“low power mode switching instruction” in step S630), the interrupt control device 4 maintains the operation state in the state management unit 404 (the low power mode transition progress state) and the transition state in the low power mode transition control unit 405 (the transition permission state), and changes the power consumption mode to the low power mode and the interrupt state in the interrupt signal generation unit 407 to the interrupt enable state (step S665). The interrupt control device 4 judges whether an instruction is received, a type of the received instruction, and whether an interrupt occurs, through condition judgment (step S670). When judging that the interrupt enable instruction is received or that no interrupt occurs and no instruction is received (“interrupt enable instruction, other” in step S670), the interrupt control device 4 returns to step S665. When judging that an interrupt occurs (“interrupt” in step S670), the interrupt control device 4 performs the interrupt handler process (step S675), and proceeds to step S660.

4.3. Specific Example

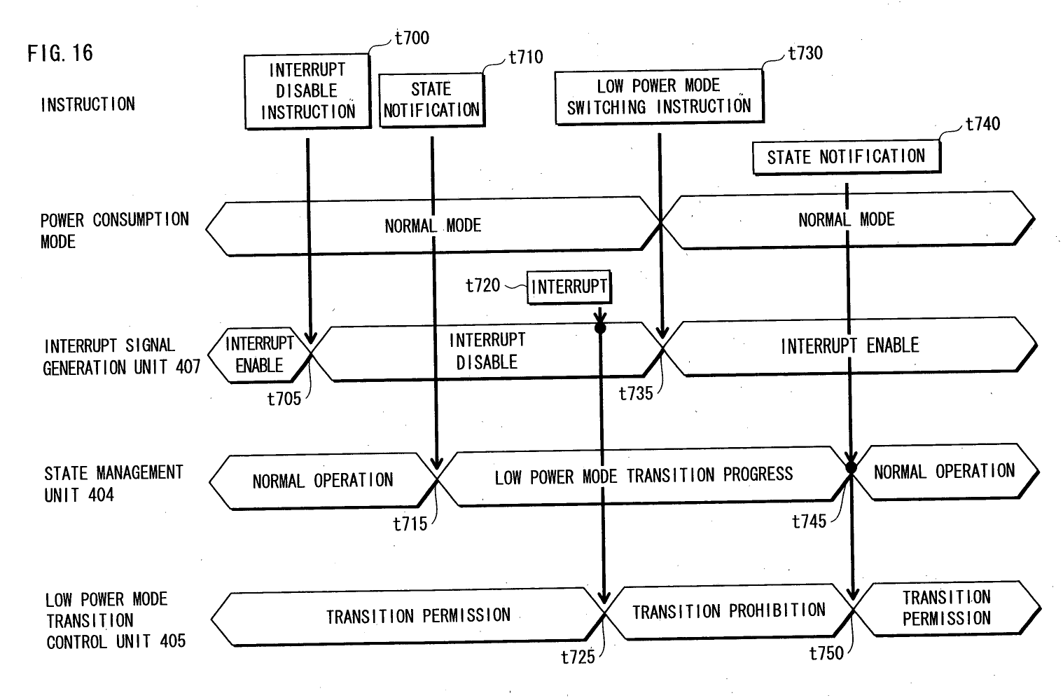

A specific operation of the interrupt control device 4 when an interrupt occurs in the low power mode transition progress state before the issuance of the low power mode switching instruction is described below, using a timing chart shown in FIG. 16.

When the microprocessor issues the interrupt disable instruction by executing the software (the transition procedure) (t700), the instruction decoding unit 400 notifies the low power mode instruction detection unit 401, the interrupt enable/disable instruction detection unit 402, and the state management unit 404 of the interrupt disable instruction.

Having received the interrupt disable instruction from the instruction decoding unit 400, the interrupt enable/disable instruction detection unit 402 notifies the interrupt signal generation unit 407 of the reception of the interrupt disable instruction. Upon being notified of the interrupt disable instruction from the interrupt enable/disable instruction detection unit 402, the interrupt signal generation unit 407 changes the interrupt state from the interrupt enable state to the interrupt disable state (t705).

When the microprocessor issues the low power mode transition progress instruction as a state notification by executing the software (the transition procedure) (t710), the instruction decoding unit 400 notifies the low power mode instruction detection unit 401, the interrupt enable/disable instruction detection unit 402, and the state management unit 404 of the low power mode transition progress instruction.

The state management unit 404 responsively changes the operation state from the normal operation state to the low power mode transition progress state (t715). The state management unit 404 then notifies the low power mode transition control unit 405 of the operation state.

Upon receiving an interrupt in the interrupt disable state (t720), the interrupt signal generation unit 407 notifies the low power mode transition control unit 405 of the reception of the interrupt, and abandons the received interrupt.

Upon being notified of the interrupt from the interrupt signal generation unit 407, the low power mode transition control unit 405 judges whether the operation state notified by the state management unit 404 is the low power mode transition progress state. In this example, the low power mode transition control unit 405 judges that the operation state is the low power mode transition progress state, and changes the transition state from the transition permission state to the transition prohibition state (t725).

When the microprocessor issues the low power mode switching instruction by executing the software (the transition procedure) (t730), the instruction decoding unit 400 notifies the low power mode instruction detection unit 401, the interrupt enable/disable instruction detection unit 402, and the state management unit 404 of the low power mode switching instruction. The low power mode instruction detection unit 401 notifies the low power mode transition control unit 405 of the reception of the low power mode switching instruction. Upon being notified of the low power mode switching instruction from the low power mode instruction detection unit 401, the low power mode transition control unit 405 judges whether the current transition state is the transition permission state or the transition prohibition state. In this example, the low power mode transition control unit 405 judges that the current transition state is the transition prohibition state, notifies the interrupt signal generation unit 407 of the reception of the low power mode switching instruction, and abandons the received low power mode switching instruction. Upon being notified of the low power mode switching instruction from the low power mode transition control unit 405, the interrupt signal generation unit 407 changes the interrupt state from the interrupt disable state to the interrupt enable state (t735).

When the microprocessor issues the normal operation instruction as a state notification by executing the software (the transition procedure) (t740), the instruction decoding unit 400 notifies the low power mode instruction detection unit 401, the interrupt enable/disable instruction detection unit 402, and the state management unit 404 of the normal operation instruction.

The state management unit 404 responsively changes the operation state from the low power mode transition progress state to the normal operation state (t745). The state management unit 404 then notifies the low power mode transition control unit 405 of the operation state.

Upon being notified of the normal operation state from the state management unit 404, the low power mode transition control unit 405 judges whether the current transition state is the transition permission state or the transition prohibition state. In this example, the low power mode transition control unit 403 judges that the current transition state is the transition prohibition state, and changes the transition state from the transition prohibition state to the transition permission state (t750).

4.4. Modifications

Though the present invention has been described by way of the above fourth embodiment, the present invention should not be limited to the above. Example modifications are given below.

(1) The fourth embodiment describes the case where the low power mode transition control unit 405 manages whether to transition to the low power mode, through the use of the transition permission state and the transition prohibition state. However, the present invention is not limited to this.

For example, the management as to whether to transition to the low power mode may be made based on the operation state managed by the state management unit 404 and whether an interrupt is received or not.

In this case, upon being notified of an interrupt from the interrupt signal generation unit 407, the low power mode transition control unit 405 judges whether the operation state notified from the state management unit 404 is the low power mode transition progress state. If the operation state is the low power mode transition progress state, the low power mode transition control unit 405 holds the interrupt notification. If the operation state is not the low power mode transition progress state, the low power mode transition control unit 405 abandons the interrupt notification.

Upon receiving the low power mode switching instruction from the low power mode instruction detection unit 401, the low power mode transition control unit 405 judges whether the interrupt notification is held. When judging that the interrupt notification is held, the low power mode transition control unit 405 notifies the interrupt signal generation unit 407 of the reception of the low power mode switching instruction, and abandons the received low power mode switching instruction. In this case, the transition to the low power mode is not carried out.

When judging that the interrupt notification is not held, the low power mode transition control unit 405 notifies the low power mode control unit 406 to transition to the low power mode.

(2) The fourth embodiment and the above modification can freely be combined.

4.5. Conclusion

According to the fourth embodiment described above, the interrupt control device 4 changes the state in accordance with the issuance of the state notification instruction, in the low power mode transition procedure. If an interrupt is received in the low power mode transition progress state, the interrupt control device 4 suppresses an unwanted transition to the low power mode. As a result, a time for recovering from the low power mode can be saved.

Also, the low power mode switching instruction issued by the microprocessor executing the software (the transition procedure) can be used by the interrupt signal generation unit 407 as the interrupt enable instruction. Which is to say, when notified of the low power mode switching instruction from the low power mode transition control unit 405 in the interrupt disable state, the interrupt signal generation unit 407 enables interrupts.

Also, the interrupt signal generation unit 407 and the interrupt signal control unit 403 do not generate an interrupt signal for a received interrupt until the low power mode switching instruction is received in the low power mode transition progress state. This enables an interrupt processing time to be reduced.

### 5. Conclusion on the First to Fourth Embodiments

As described in the above first to fourth embodiments, when an interrupt is received in the low power mode transition procedure by the microprocessor operating in accordance with the software, the unwanted transition to the low power mode is suppressed to thereby reduce a time for recovering from the low power mode.

The interrupt control device of the present invention makes it possible to return from the low power mode in a short time. The present invention is applicable to any interrupt control device having a low power mode function.

The present invention has a characteristic construction that includes: an interrupt signal control unit operable to detect an interrupt; an interrupt disable expectation judgment unit operable to judge a section following permission of wakeup interrupts; and a low power mode transition prohibition unit operable to prohibit transitioning to a low power mode when a low power mode instruction is issued during the section.

Also, the present invention has a characteristic construction that includes: an interrupt signal control unit operable to control an interrupt; a low power mode instruction detection unit operable to detect a low power mode switching instruction; a state management unit operable to manage an operation state which is any of a normal operation state and a low power mode transition progress state; and a low power mode transition prohibition unit operable to disable the low power mode switching instruction when the interrupt occurs in the low power mode transition progress state.

Also, the present invention has a characteristic construction that includes: an interrupt signal control unit operable to control an interrupt; a low power mode instruction detection unit operable to detect a low power mode switching instruction; a state management unit operable to manage an operation state which is any of a normal operation state and a low power mode transition progress state; and a low power mode change control unit operable to change a low power mode (clock stop) instruction to a low power mode (clock operation) instruction when the interrupt occurs in the low power mode transition progress state.

Also, the present invention has a characteristic construction that includes: an interrupt signal control unit operable to control an interrupt; a low power mode instruction detection unit operable to detect a low power mode switching instruction; a state management unit operable to manage an operation state which is any of a normal operation state and a low power mode transition progress state; a low power mode transition prohibition unit operable to disable the low power mode switching instruction when the interrupt occurs in the low power mode transition progress state; and an interrupt signal generation unit operable to suppress generation of an interrupt signal in the low power mode transition progress state.

### 6. Industrial Applicability

The present invention can be used recurrently and continuously in an industry for producing and selling interrupt control devices having a low power mode function.

Although the present invention has been fully described by way of examples with reference to the accompanying drawings, it is to be noted that various changes and modifications will be apparent to those skilled in the art.

Therefore, unless such changes and modifications depart from the scope of the present invention, they should be construed as being included therein.

What is claimed is:

1. An interrupt control device for controlling an interrupt to a target device and switching of the target device between a normal power mode and a low power mode, comprising:
an interrupt reception unit operable to receive the interrupt;
an instruction reception unit operable to receive a switching instruction to switch the target device from the normal power mode to the low power mode, the switching instruction being included in a transition program showing a transition procedure from the normal power mode to the low power mode;
a state management unit operable to manage an interrupt state, by switching between an interrupt disable state of disabling any interrupt, a first interrupt enable state of enabling an interrupt in a period of the transition procedure according to the transition program, and a second interrupt enable state of enabling an interrupt in a period other than the period of the transition procedure; and
a transition control unit operable to, if the interrupt reception unit receives the interrupt in the first interrupt enable state, abandon the switching instruction when subsequently the instruction reception unit receives the switching instruction.

2. The interrupt control device of claim 1, wherein
the transition control unit manages a transition state indicating whether to permit transitioning from the normal power mode to the low power mode, and
the transition control unit sets the transition state to a transition prohibition state of prohibiting transitioning to the low power mode when the interrupt reception unit receives the interrupt in the first interrupt enable state, and abandons the switching instruction when the instruction reception unit receives the switching instruction in the transition prohibition state.

3. An interrupt control device for controlling an interrupt to a target device and switching of the target device between a normal power mode and a low power mode, comprising:
an interrupt reception unit operable to receive the interrupt;
an instruction reception unit operable to receive a switching instruction to switch the target device from the normal power mode to the low power mode, the switching instruction being included in a transition program showing a transition procedure from the normal power mode to the low power mode;
an interrupt state management unit operable to manage an interrupt state, by switching between an interrupt enable state of enabling an interrupt and an interrupt disable state of disabling an interrupt;
an operation state management unit operable to manage an operation state indicating whether the transition procedure according to the transition program is being performed, the operation state being set to a transition progress state if the transition procedure is being performed; and
a transition control unit operable to, if the interrupt reception unit receives the interrupt in the interrupt disable state and the transition progress state, abandon the switching instruction when subsequently the instruction reception unit receives the switching instruction.

4. The interrupt control device of claim 3, wherein
the transition control unit manages a transition state indicating whether to permit transitioning from the normal power mode to the low power mode,
the transition control unit sets the transition state to a transition prohibition state of prohibiting transitioning to the low power mode when the interrupt reception unit receives the interrupt in the interrupt disable state and the transition progress state, and abandons the switching instruction when the instruction reception unit receives the switching instruction in the transition prohibition state, and
the interrupt state management unit changes the interrupt state from the interrupt disable state to the interrupt enable state when the transition control unit abandons the switching instruction.

5. The interrupt control device of claim 4, further comprising:
an interrupt signal control unit operable to generate an interrupt signal for the interrupt received by the interrupt reception unit, when the instruction reception unit receives the switching instruction,
the transition control unit changes the transition state from the transition prohibition state to a transition permission state of permitting transitioning to the low power mode, upon detecting the interrupt signal generated by the interrupt signal control unit, and
the operation state management unit changes the operation state from the transition progress state to a normal operation state indicating that the target device is in the normal power mode, when the transition control unit changes the transition state from the transition prohibition state to the transition permission state.

6. The interrupt control device of claim 4, wherein
the instruction reception unit further receives normal mode information showing that the target device is in the normal power mode,
the operation state management unit changes the operation state from the transition progress state to a normal operation state indicating that the target device is in the normal power mode, when the instruction reception unit receives the normal mode information, and
the transition control unit changes the transition state from the transition prohibition state to a transition permission state of permitting transitioning to the low power mode, when the instruction reception unit receives the normal mode information.

7. The interrupt control device of claim 3, controlling switching of a plurality of target devices between the normal power mode and the low power mode, wherein
if the interrupt reception unit receives the interrupt in the interrupt disable state and the transition progress state, the transition control unit stops a clock to a target device except a main target device when subsequently the instruction reception unit receives the switching instruction, and
the interrupt state management unit changes the interrupt state from the interrupt disable state to the interrupt enable state, when the transition control unit stops the clock.

8. The interrupt control device of claim 7, further comprising:
an interrupt signal control unit operable to generate an interrupt signal for the interrupt received by the interrupt reception unit, when the instruction reception unit receives the switching instruction,
the transition control unit resumes the clock, upon detecting the interrupt signal generated by the interrupt signal control unit, and
the operation state management unit changes the operation state from the transition progress state to a normal operation state indicating that all of the plurality of target devices are in the normal power mode, when the transition control unit resumes the clock.

9. A control method used in an interrupt control device for controlling an interrupt to a target device and switching of the target device between a normal power mode and a low power mode, comprising steps of:
receiving the interrupt;
receiving a switching instruction to switch the target device from the normal power mode to the low power mode, the switching instruction being included in a transition program showing a transition procedure from the normal power mode to the low power mode;
managing an interrupt state, by switching between an interrupt disable state of disabling any interrupt, a first interrupt enable state of enabling an interrupt in a period of the transition procedure according to the transition program, and a second interrupt enable state of enabling an interrupt in a period other than the period of the transition procedure; and
abandoning, if the interrupt reception step receives the interrupt in the first interrupt enable state, the switching instruction when subsequently the instruction reception step receives the switching instruction.

10. A control method used in an interrupt control device for controlling an interrupt to a target device and switching of the target device between a normal power mode and a low power mode, comprising steps of:
receiving the interrupt;
receiving a switching instruction to switch the target device from the normal power mode to the low power mode, the switching instruction being included in a transition program showing a transition procedure from the normal power mode to the low power mode;
managing an interrupt state, by switching between an interrupt enable state of enabling an interrupt and an interrupt disable state of disabling an interrupt;
managing an operation state indicating whether the transition procedure according to the transition program is being performed, the operation state being set to a transition progress state if the transition procedure is being performed; and
abandoning, if the interrupt reception step receives the interrupt in the interrupt disable state and the transition progress state, the switching instruction when subsequently the instruction reception step receives the switching instruction.
